(19) United States
(12) Patent Application Publication
(10) Pub. No.: US 2025/0282603 A1
(43) Pub. Date: Sep. 11, 2025

(54) Gravity Device

(71) Applicant: Gate CFV Solutions, Inc., SEBASTIAN, FL (US)

(72) Inventors: GILLIAN CALLAGHAN, Vero Beach, FL (US); Rory Pawl, Vero Beach, FL (US); Dustin Hartsfield, SEBASTIAN, FL (US); Vincent Juliana, Chester Spring, PA (US); Josephine Abigail Palmateer, Palm Bay, FL (US); Keith Michael Boyle, Sebastian, FL (US); Jameel Abdul Ahed, Cape Coral, FL (US); Alberto Jose Paredes, Cape Coral, FL (US)

(73) Assignee: Gate CFV Solutions, Inc., SEBASTIAN, FL (US)

(21) Appl. No.: 19/072,099

(22) Filed: Mar. 6, 2025

Related U.S. Application Data
(60) Provisional application No. 63/562,475, filed on Mar. 7, 2024.

(51) Int. Cl. B67D 1/08; B67D 1/00; B67D 1/07; B67D 1/12

(52) U.S. Cl. CPC B67D 1/0888; B67D 1/07; B67D 1/0877; B67D 1/1281; B67D 2001/0093

(57) ABSTRACT

This disclosure relates to a dispensing system including: a display screen which displays one or more icons, the one or more icons including at least a first icon, a second icon, and a third icon, the display screen may transmit one or more signals to one or more processors based on one or more user contacts with the display screen, the one or more processors may receive at least a first sales data, a second sales data, and a third sales data, where the one or more processors may: modify a first size of the first icon based on a first sales data for a first element relating to the first icon; modify a second size of the second icon based on a second sales data for a second element relating to the second icon; and modify a third size of the third icon based on a third sales data for a third element relating to the third icon; and a first dispensing unit which may dispense one or more elements based on the one or more signals.

### PRIORITY INFORMATION

The present application claims priority to Provisional Patent Application No. 63/562,475 filed Mar. 7, 2024, which is incorporated in its entirety by reference.

### BACKGROUND DISCUSSION

The dispensing industry is becoming more complex based on customer demand for customized drinks. These customized drinks require precision applications of various liquids and gases. In addition, material cost, labor cost, and labor safety are important factors that need to be enhanced. Further, customers demand a high level of cleaning to ensure that these customized drinks are safe. By utilizing this disclosure, the operator can achieve clean, customized, precision drinks with reduced material cost and labor cost while increase labor safety. In addition, customizable user interfaces can increase sales and customer satisfaction.

### BRIEF DESCRIPTION OF THE DRAWINGS

FIGS. 1A-1D are illustrations of an exemplary embodiment of various user interfaces and marketing screens, according to one embodiment;

FIG. 2A is an illustration depicting a maintenance screen/interface, according to one embodiment;

FIG. 2B is an illustration of a customer utilizing a mobile device to interact with the dispensing device, according to one embodiment;

FIG. 2C is an illustration of a drink selection process, according to one embodiment;

FIG. 2D is an illustration of a drink management function, according to one embodiment;

FIG. 3 is an illustration of a sensor system utilizing in the dispensing device, according to one embodiment;

FIG. 4 is a block diagram of the dispensing system, according to one embodiment;

FIG. 5 is an illustration of a sold out condition, according to one embodiment;

FIG. 6 is an illustration of user interface with various drink data, according to one embodiment;

FIG. 7 is a block diagram of the dispensing system, according to one embodiment;

FIG. 8 is an illustration of the dispensing system, according to one embodiment;

FIG. 9 is a drink selection flowchart, according to one embodiment;

FIG. 10 is an illustration of the pressurized container containing a bag, according to one embodiment;

FIGS. 11A-11D are illustrations of a customizable drink dispensing system, according to various embodiments;

FIG. 12 is an illustration of a bag in a pressurized dispensing system, according to one embodiment;

FIG. 13A is a block diagram of a dispensing system, according to one embodiment;

FIG. 13B is an illustration of a dispensing system, according to one embodiment;

FIGS. 14A-14B are illustrations of drinking dispensing flowcharts, according to various embodiments;

FIGS. 15A-15D are illustrations of drink dispensing systems, according to various embodiments;

FIGS. 16A-16D are illustrations of drink dispensing systems, according to various embodiments;

FIG. 17 is an illustration of a CF Valve, according to one embodiment;

FIG. 18 is another illustration of a CF Valve, according to one embodiment;

FIG. 19 is an illustration of the drink dispensing device, according to one embodiment;

FIG. 20A is a flowchart illustration of the customizable drink dispensing system, according to one embodiment;

FIG. 20B is an illustration of a customizable drink dispensing device, according to one embodiment;

FIGS. 21A-21D are illustrations of dispensing devices, according to various embodiments;

FIGS. 22A-22D are illustrations of customizable dispensing devices and customizable cleaning systems, according to various embodiments;

FIGS. 23A-23C are illustrations of attachment functions for dispensing devices, according to various embodiments;

FIGS. 24A-24D are illustrations of the attachment device for the dispensing devices, according to various embodiments;

FIGS. 25A-25B are illustrations of dispensing devices, according to various embodiments;

FIG. 25C shows a block diagram of a dispensing device, according to one embodiment;

FIGS. 26A-26B are illustrations of the attachment device, according to various embodiments;

FIGS. 27A-27B are illustrations of a dispensing devices, according to various embodiments;

FIG. 28 is an illustration of an ice rack, according to one embodiment;

FIG. 29 is an illustration of a cooling system, according to one embodiment;

FIG. 30 is another illustration of a cooling system, according to one embodiment;

FIG. 31 is another illustration of a cooling system, according to one embodiment;

FIG. 32 is an illustration of an ice rack, according to one embodiment;

FIG. 33 is another illustration of an ice rack, according to one embodiment;

FIG. 34 is an illustration of a user interface for a dispensing system, according to one embodiment;

FIGS. 35A-35B are illustrations of a CFiVe Switch cap, according to various embodiments;

FIG. 36 is an illustration of a dispensing system, according to one embodiment;

FIG. 37 is an illustration of a ventless CF Valve, according to one embodiment;

FIGS. 38A-38B are illustrations of a ventless CF Valve, according to various embodiments;

FIG. 39 is an illustration of pressures which can be utilized with the ventless CF Valve; according to various embodiments;

FIGS. 40A-40B are illustrations of a ventless CF Valve versus a vented CF Valve, according to various embodiments;

FIGS. 41A-41B are illustrations of a ventless CF Valve versus a vented CF Valve, according to various embodiments;

FIGS. 42A-42B are illustrations of a ventless CF Valve versus a vented CF Valve, according to various embodiments;

FIGS. 43A-43B are illustrations of a ventless CF Valve versus a vented CF Valve, according to various embodiments; and

FIGS. 44A-44B are illustrations of a ventless CF Valve versus a vented CF Valve, according to various embodiments.

### DETAILED DESCRIPTION

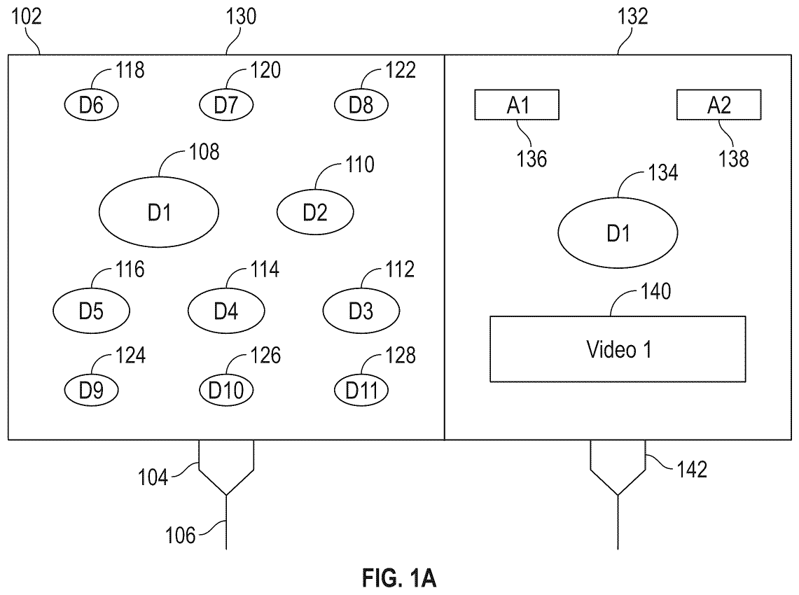

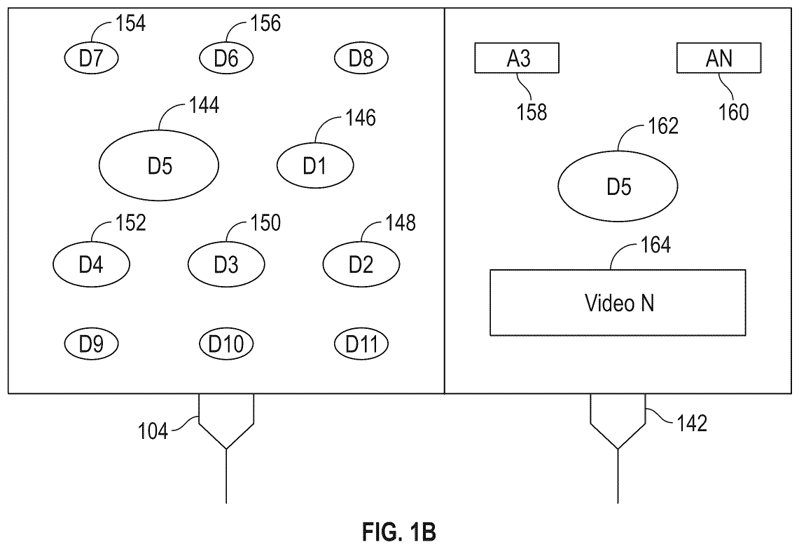

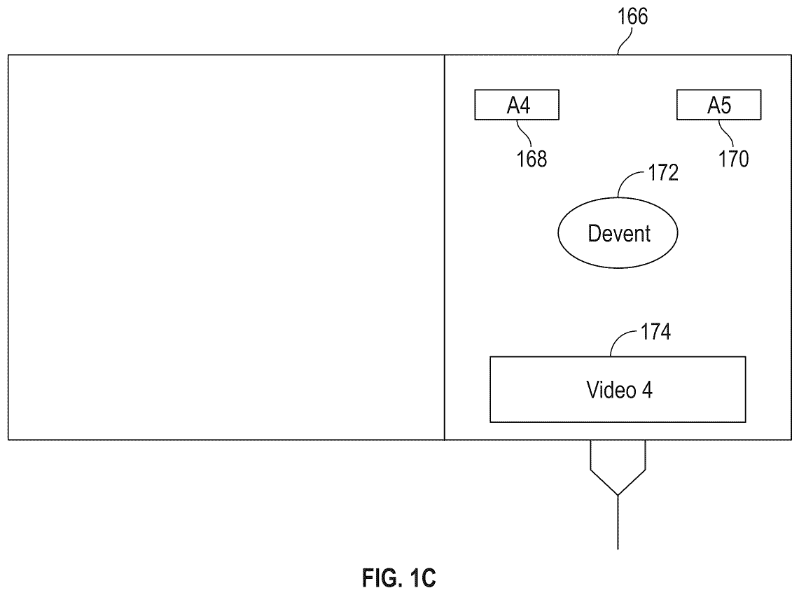

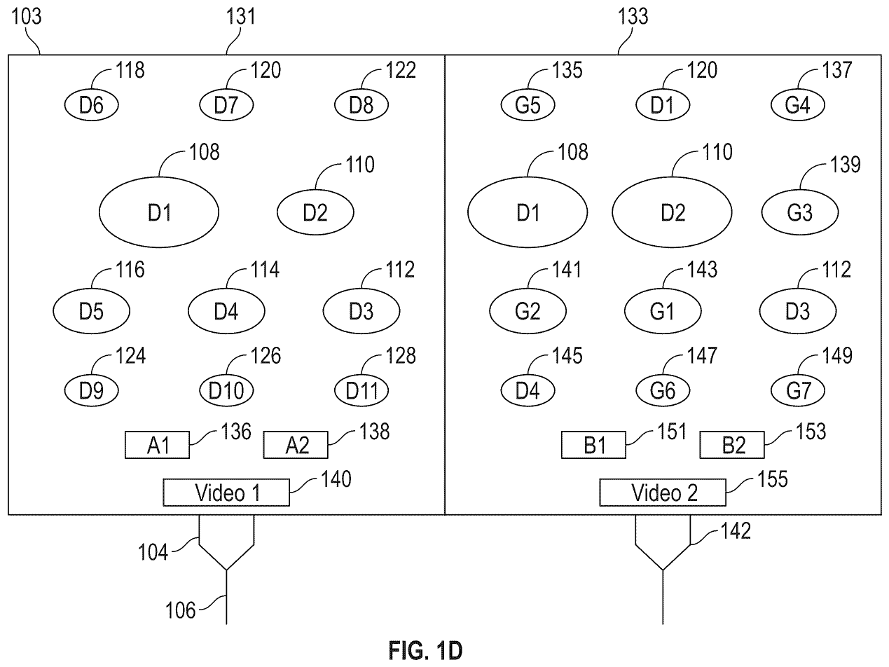

FIGS. 1A-1D are illustrations of an exemplary embodiment of various user interfaces and marketing screens, according to one embodiment;

FIG. 1A shows a display 102 with a first display screen 130 and a second display screen 132 (and/or Nth display screen). In one example, the first display screen 130 may include a first display item 108, a second display item 110, a third display item 112, a fourth display item 114, a fifth display item 116, a sixth display item 118, a seventh display item 120, an eighth display item 122, a nineth display item 124, a tenth display item 126, and an Nth display item 128.

In various embodiments, the size of the icon (e.g., circle(s) in FIG. 1A) corresponds with the amount of sales the specific drink has had over a specific time period. In one example, drink 1 (D1) has had the highest amount of sales and drink 11 (D11) has had the least amount of sales. This is represented by the icon for D1 being the largest icon on the first display screen 130 and the icon for D11 being the smallest icon on the first display screen 130. In this example, the icons for D2, D3, D4, and D5 have a medium size, which represents average sales volume. Whereas, the icons for D6, D7, D8, D9, D10, and D11 have a small size, which represents below average sales volume. As previously stated, the icon for D1 is the largest based on sales volume. In addition to the size of the icon changing, the location of the icon may be independently and/or in conjunction with a size change be changed based on sales data, time-of-day, a promotional, an event, and/or any other event disclosed in this document.

In another example, the second display screen 132 may include a first advertisement area 136 and a second advertisement area 138 (and/or an Nth advertisement area). Further, the second display screen 132 may include a first display item 134 and a first video area 140.

In various embodiments, the first advertisement area 136, the second advertisement area 138, and/or first video area 140 may be utilized to advertise the bestselling product (D1) (and/or a worst selling product and/or an expiring product and/or a newly released product and/or any other criteria disclosed in this document) and/or any of the other drinking products and/or any other products (e.g., hot dog, chips, etc.). In one example, the first advertisement area 136 and the second advertisement area 138 are screen shots. Whereas, the first video area 140 is a streaming image. It should be noted that the first advertisement area 136 and the second advertisement area 138 may also be streaming videos and/or any other communication element. It should be noted that the display area may be on one screen and/or multiple screens.

In one example, a first dispensing area 104 is located at the bottom of the first display screen 130 and a second dispensing area 142 is located at the bottom of the second display screen 132. In addition, a dispensing fluid 106 is shown. It should be noted that dispensing area may located anywhere on the dispensing machine and not directly coupled to the display area.

FIG. 1B shows modified display item areas. In this example, the fifth display item 116 from FIG. 1A usage has increasing making the fifth display item 116 the most popular (e.g., the highest number of purchases, the highest volume of purchases, etc.) and is now has the biggest display area. Therefore, the drink associated with the fifth display item 116 has moved to first display item area 144. Further, the drink associated with the first display item area 108 from FIG. 1A has moved to the second display item area 146 of FIG. 1B because its usage and/or number of purchases and/or volume of purchases is less than the drink associated with the first display area 144.

In an example, the most popular drink may be shown in a center display area 162 with a third advertisement 158 and/or an Nth advertisement 160 and/or an Nth video 164 displayed.

In various embodiments, one or more drinks may be ranked from most popular (e.g., highest sales) to least popular (e.g., lowest sales) and based on these rankings one or more icons may be assigned to one or more drinks (and/or products). For example, drink five (D5) has the fifth most popular drink on FIG. 1A. However, drink five (D5) has become the most popular drink and now has a large icon 144 associated with drink five. Whereas, drink one (D1) was the most popular drink on FIG. 1A but now has become the second most popular drink and now has a second largest icon 146 associated with drink one. In one example, D2, D3, D4, D6, D7, D8, D9, D10, and D11 have varying icon sizes (and/or locations) based on the amount of sales volume (and/or number of units sold). In this example, the third advertisement 158 and/or an Nth advertisement 160 and/or an Nth video 164 may be associated with drink five (D5) and D5 displayed in the center of the display area as large icon 162.

FIG. 1C shows an event drink being displayed in the event drink area 172, a fourth advertisement area 168, a fifth advertisement area 170 (and/or Nth advertisement area), and a fourth video area 174 (and/or an Nth video area).

In various embodiments, a drink icon related to an event is shown as an event drink icon 172. For example, a champion football game may have a first team and a second team playing in the champion football game. For a certain time period and/or geographical area and/or time of day and/or any other criteria, a drink event icon 172 may show a quarterback's favorite drink and/or drink combination (e.g., cherry soda). In another example, the circus may be in town and for a certain time period and/or geographical area and/or time of day and/or any other criteria, a drink event icon 172 may show an elephant drink, a lion drink, a clown drink, etc. In another example, a tournament (e.g., golf, poker, pool, bowling, etc.) may be in town and for a certain time period and/or geographical area and/or time of day and/or any other criteria, a drink event icon 172 may show an a golf player's favorite drink (e.g., the hole in one), a poker player's favorite drink (e.g., the straight flush), a pool player's favorite drink (e.g., the combo), and/or the bowling player's favorite drink (e.g., the strike and/or the turkey). In various examples, a fourth advertisement area 168, a fifth advertisement area 170 (and/or Nth advertisement area), and a fourth video area 174 (and/or an Nth video area) may be utilized to support the event.

FIG. 1D show a display 103 with a first display screen 131 and a second display screen 133. In one example, display 103 may be one device, two device, and/or N devices. In one example, the first display screen 131 may include the first display item 108, the second display item 110, the third display item 112, the fourth display item 114, the fifth display item 116, the sixth display item 118, the seventh display item 120, the eighth display item 122, the nineth display item 124, the tenth display item 126, the Nth display item 128, a first advertisement area 136, a second (and/or Nth) advertisement area 138, and/or a first video area 140. In this example, the second display screen 133 may include a first display item 135, the seventh display item 120, a second display item 137, the first display item 108 (from FIG. 1A), the second display item 110 (from FIG. 1A), a third display item 139, a fourth display item 141, a fifth display item 143, the third display item 112 (from FIG. 1A), a sixth display item 145, a seventh display item 147, an eighth display item 149, a first advertisement 151, a second (and/or Nth) advertisement 153, and/or a Nth video stream 155. In addition, one or more dispensing areas (104 and 142) are shown.

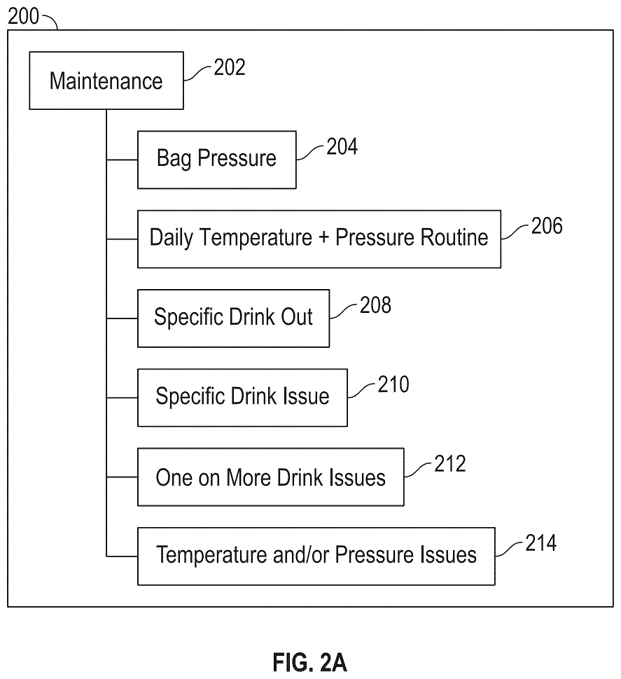

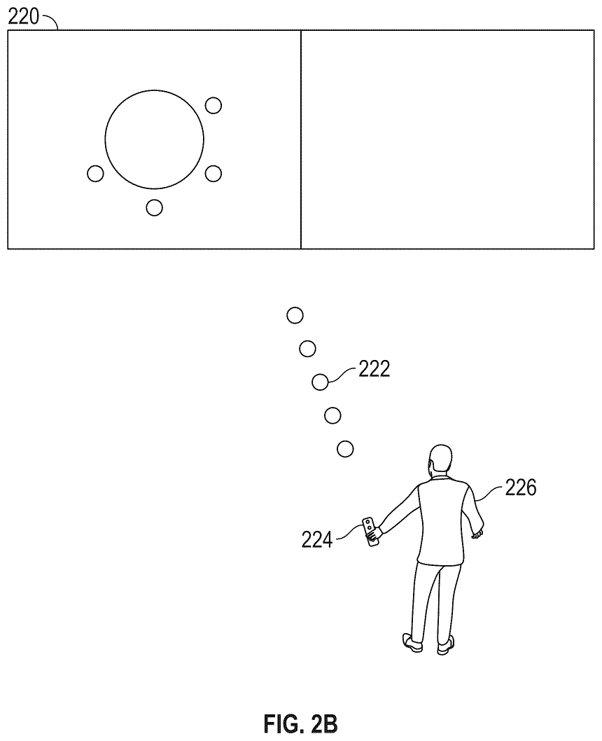

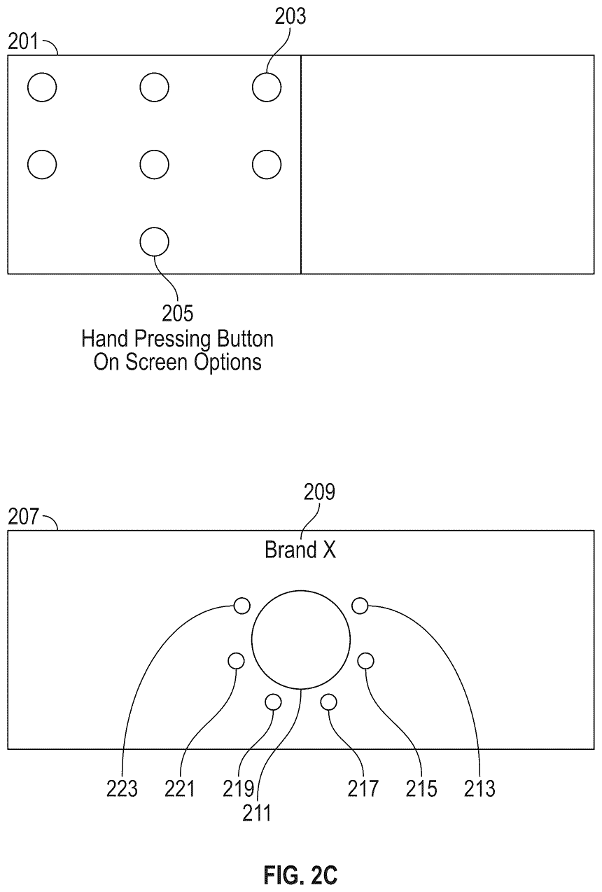

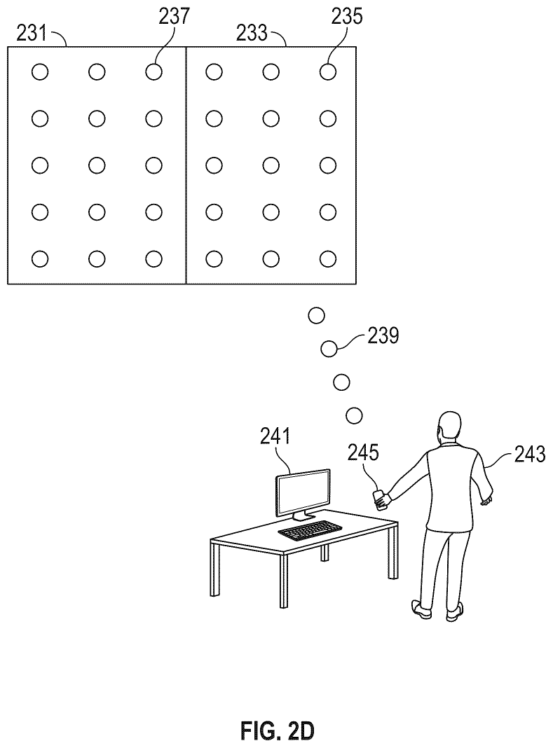

FIG. 2A shows a maintenance display screen 200 with a maintenance overview area 202. The maintenance overview area 202 may include a bag pressure 204, a daily temperature and pressure routine 206, a specific drink out 208, a specific drink issue 210, one or more drink issues 212, and one or more temperature and/or pressure issues 214.

In various embodiments, a maintenance screen 200 may include a first maintenance area 202. First maintenance area 202 may have a bag pressure data area 204, a daily temperature and pressure routine data area 206, a specific drink out data area 208, a specific drink data area 210, one or more drink issues data area 212, a temperature and/or pressure issues and/or any other maintenance data. In one embodiment, the bag pressure data area 204 may include one or more bag pressures which may be utilized to determine a sold out condition. In another example, one or more drinks may require a daily temperature procedure and/or pressure procedure which can be controlled via a controller utilizing data from the daily temperature and pressure routine data area 206. In another example, a first drink may be out for 4 hours while a second drink was out for 2 days which could be stored in the specific drink out data area 208. Further, the cause of the drink out condition may be stored in the specific drink out data area 208. In addition, one or more temperature and/or pressure issues may be stored and/or the solution to the issues may be stored in a temperature and/or pressure issues data area 214.

FIG. 2B shows one or more display screens 220 with one or more drink item areas, one or more advertisements, and/or one or more videos which can be communicated via the internet 222 to one or more remote devices 224 operated by one or more individuals 226. Further, data relating to one or more drinks, maintenance, cleaning, promotions, sales, sports teams, etc. may be transmitted.

In various embodiments, the data relating to one or more drinks may be transmitted from the dispensing device 220 via a communication element (e.g., wired, wireless, and/or both) to one or more remote devices. Further, the user may preorder their drink selection which will be ready to be dispensing once the user is at the dispensing device.

FIG. 2C shows a user interface 201 on a dispensing device. In one example, the user interface 201 may include one or more drink selection options 203. In this example, the user selects a specific drink option 205. Based on the specific drink option 205 being selected, a detailed drink selection option screen 207 is shown to the user. The detailed drink selection option screen 207 includes a brand area 209, a main drink selection option 211 (e.g., Coke), a first added drink selection option 213 (e.g., cherry), a second added drink selection option 215 (e.g., vanilla), a third added drink selection option 217 (e.g., sugar free), a fourth added drink selection option 219 (e.g., lime), a fifth added drink selection option 221 (e.g., energy shot), and/or an Nth added drink selection option 223 (e.g., slurry—extra cold).

FIG. 2D shows a first display screen 231 and a second display screen 233. The first display screen 231 has a first plurality of drink options 237 and the second display screen 233 has a second plurality of drink options 235. The first plurality of drink options 237 may be the same, completely different, and/or similar (e.g., some overlay) to the second plurality of drink options 235. In one example, one or more of the drinking options in the first plurality of drink options 237 and/or the second plurality of drink options may be changed, modified, deleted, and/or added via a wireless 239 (and/or wired not shown) connection to a computer 241 and/or a mobile device 245 via a user 243 and/or an automated function.

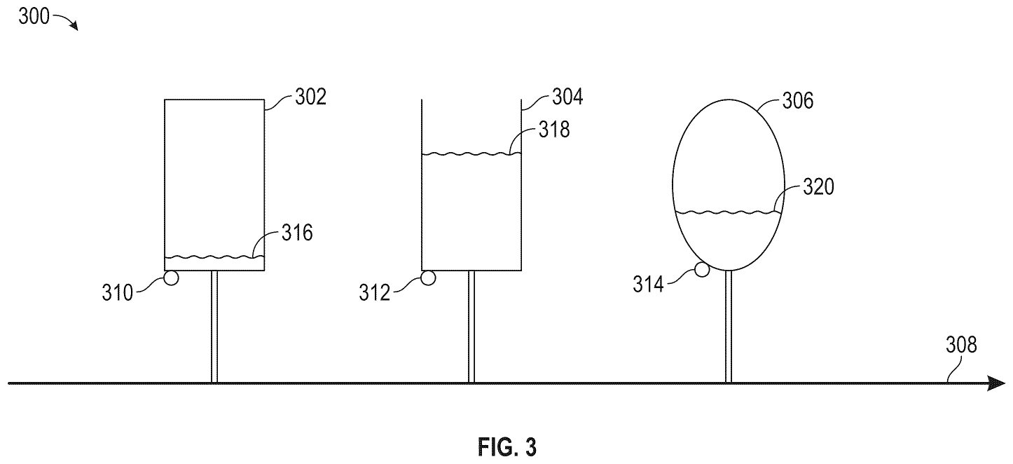

FIG. 3 shows a dispensing system 300 with a first dispenser 302, a second dispenser 304, and/or an Nth dispenser 306. In one example, the first dispenser 302 has a first sensor 310 which determines a first drink level 316. Further, the second dispenser 304 has a second sensor 312 which determines a second drink level 318. In addition, the Nth dispenser 306 has an Nth sensor 314 which determines a Nth drink level 320. In this example, a drink flow 308 is determined via opening one or more valves of the first drink dispenser 302, the second drink dispenser 304, and/or the Nth drink dispenser 306.

In various embodiments, one or more drinks may be created by opening valves on the first dispenser 302, the second dispenser 304, and/or the Nth dispenser 306 via a drink recipe data (e.g., open valve one for 1 second, valve 2 for 0.5 seconds, and valve N for 0.75 seconds. Further, one or more sensors may determine a time left before empty condition status. In other words, the first dispenser 302 has 1 hour of inventory left based on a first dispenser current usage rate, the second dispenser 304 has 2 days of inventory left based on a second dispenser current usage rate, and the Nth dispenser 306 has 7 days of inventory left based on an Nth dispenser current usage rate. Please note the even though the second dispenser 304 has a higher volume (e.g., 318 versus 320) then the Nth dispenser 306, the second dispenser 304 will run out of liquid sooner because its usage rate is higher than the Nth dispenser's usage rate.

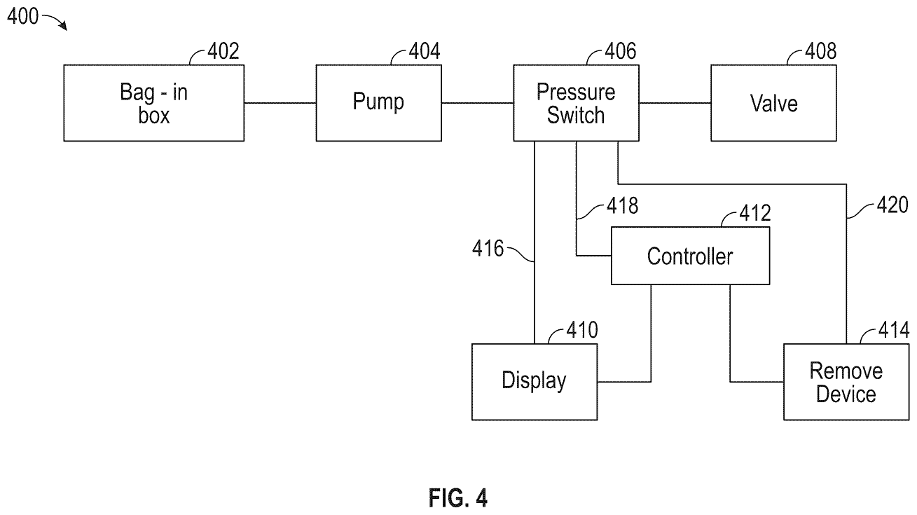

FIG. 4 shows a dispensing device 400 which may include a bag-in-box 402 (and/or bag-in-bottle), a pump 404, a pressure switch 406, a valve 408, a display 410, a controller 412, one or more remote device 414, and/or one or more communication connections (e.g., 416, 418, 420, etc.).

In various embodiments, the pressure switch 406 may obtain a sold out status because the pressure from the pump 404 is below a threshold amount. In this condition, the pressure switch 406 may send a signal to the display 410, the controller 412, and/or one or more remote devices 414 that a sold out condition exists. In addition, the drink will not be allowed to be dispensed.

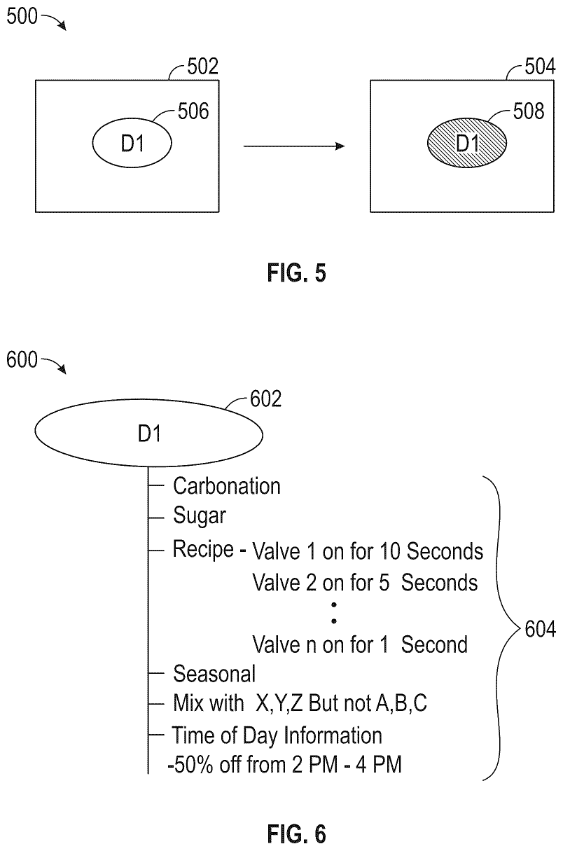

FIG. 5 shows a first display status 502 with a first drink item area 506 and a second display status 504 with a first shaded drink item area 508. In this embodiment, the first status 502 is that the first drink associated with the first drink item area 506 is available to be produced which is indicated by a lit up icon. Whereas, the second status 504 is that the first drink associated with the first drink item is unavailable based on a shaded icon 508.

FIG. 6 shows a drink item area 602. Drink item area 602 may include data including a carbonation, a sugar status, a recipe, a seasonal status, a mixing status, and/or a time of day information which are included in the data area 604.

In various embodiments, a drink data area 600 may include one or more drink criteria data areas 602. In this example, a first drink (D1) may be a carbonated drink, have sugar, have a first recipe, be included in a seasonal drink process, a mixture data, and/or a time-of-day information. Therefore, when a client selects a carbonated drink option and a sugar option, then D1 would be displayed. However, if the client selects a carbonated drink option with a sugarless option, then D1 would not be displayed. In addition, D1 was selected, then A, B, and C drink options would not be available because drinks A, B, and C cannot be mixed with D1.

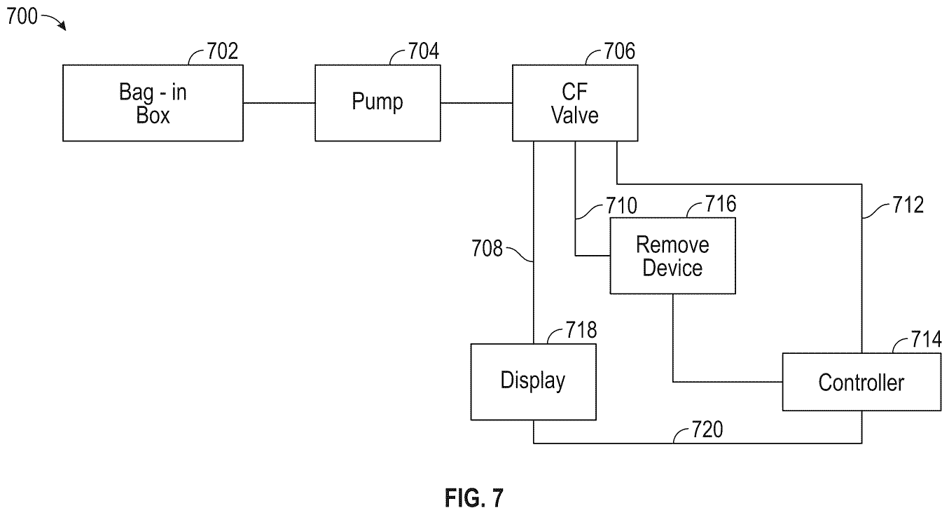

FIG. 7 shows a dispensing system 700 with a bag-in-box 702, a pump 704, a CFValve 706, one or more communication elements (e.g., 708, 710, 712, etc.), a controller 714, a remote device 716, a display 718, and an Nth communication element 720.

In various embodiments, the CFValve 706 may obtain a sold out status because the pressure from the pump 704 and/or any other pressure source is below a threshold amount. In this condition, the CFValve 706 may send a signal to the display 718, the controller 714, and/or one or more remote devices 716 that a sold out condition exists. In addition, the drink will not be allowed to be dispensed.

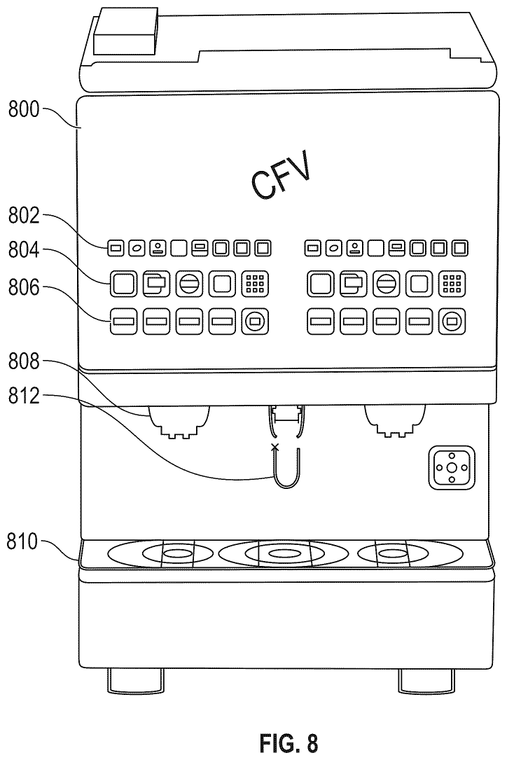

In FIG. 8, an illustration of the dispensing system 800 is shown, according to one embodiment. In one example, the dispensing system 800 includes one or more small sized drink icons 802, one or more medium sized drink icons 804, one or more large sized drink icons 806, one or more drink dispensing areas 808, one or more ice dispensing areas 812, and/or an ice tray 810. In various examples, a drink option has an icon size and/or location based on the volume of sales (e.g., the larger the sales the larger the icon and the smaller the sales volume the smaller the icon), promotions (e.g., a larger icon based on the drink being promoted and/or on sale), specific theme (e.g., champion game-Gatorade may have a larger size), time of day (e.g., X drink is more popular in the morning whereas Y drink is more popular in the afternoon—Therefore, X drink has a larger icon in the morning and Y drink has a larger icon in the afternoon).

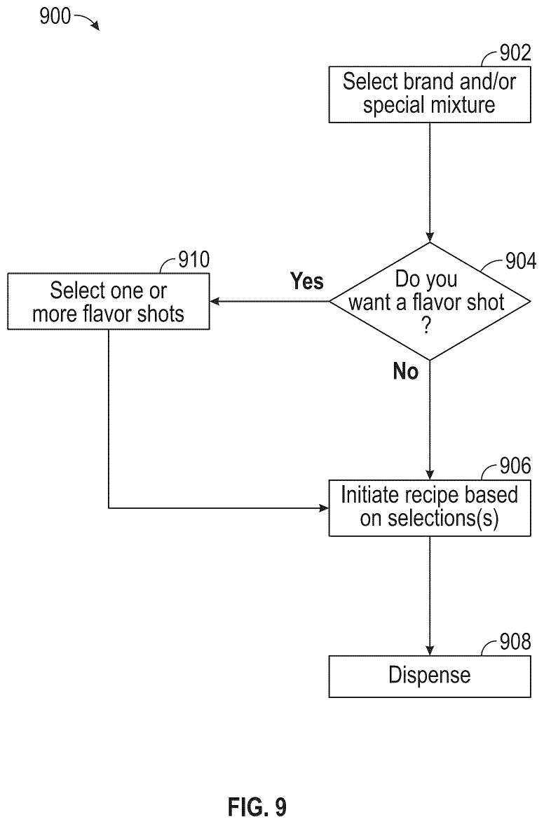

In FIG. 9, a drink selection flowchart 900 is shown, according to one embodiment. In one example, the method 900 may include selecting a brand and/or special mix (step 902). Further, the method 900 may include does the user want a flavor shot (and/or any other additive) (step 904). If the answer is yes, then the method 900 may include selecting one or more flavor shots (and/or any other additive) (step 910). The method 900 may include initiating a recipe based on the selections (step 906) and the method may include dispensing the drink (step 908). If the answer is no, then the method may initiate the recipe based on the selection (step 906) and dispense the drink (step 908).

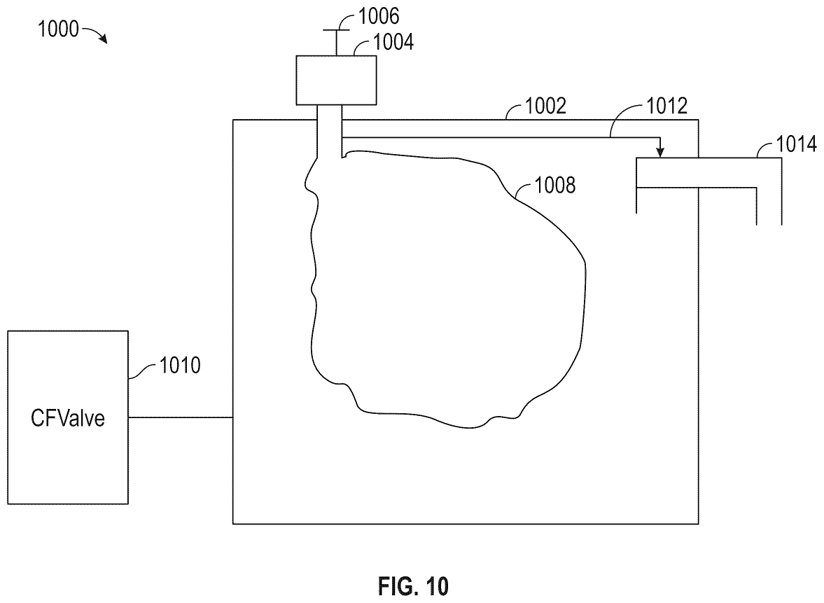

In FIG. 10, an illustration of a pressurized container containing a bag 1000 is shown, according to one embodiment. In one example, the pressurized container 1000 may include a container 1002, a file cap 1004, a pressure release device 1006, a bag 1008, a CF Valve 1010, one or more mixing areas 1012, and/or a dispensing area 1014. In this example, the pressurized container 1000 may be utilized with any dispensing device and/or system disclosed in this document.

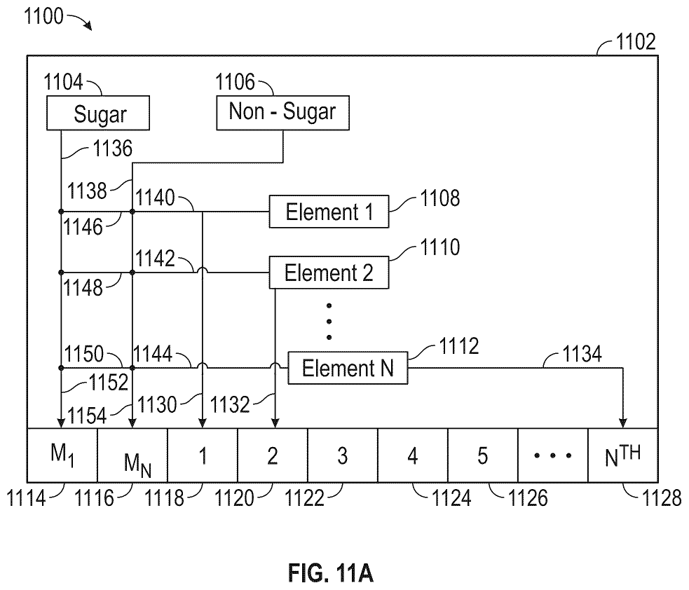

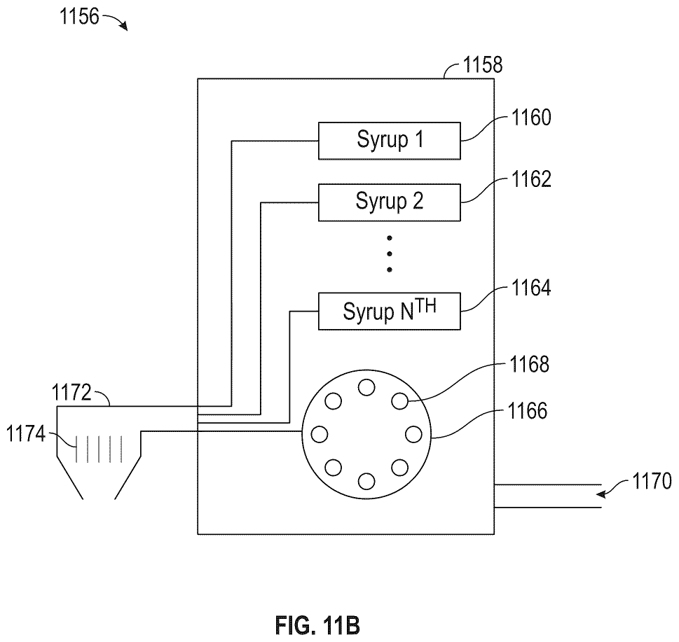

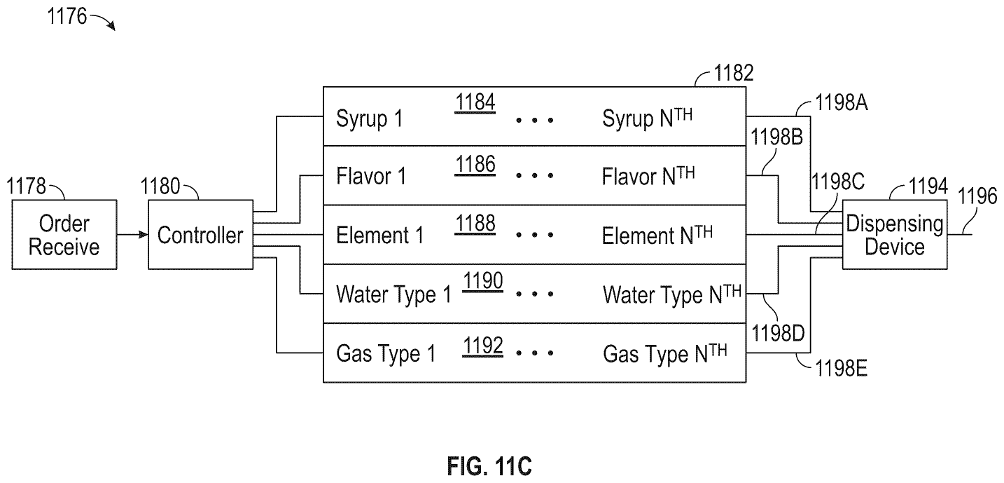

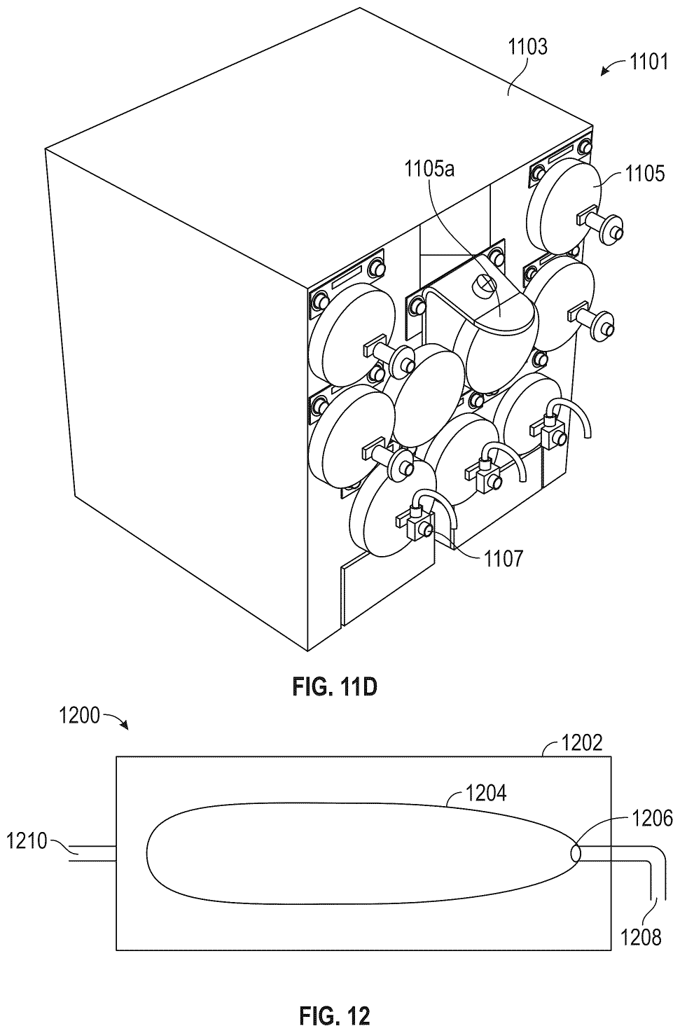

In FIGS. 11A-11D, illustrations of a customizable drink dispensing system are shown, according to various embodiments. FIG. 11A shows a dispensing system 1100 including a housing 1102, a sugar source 1104 (e.g., a first ingredient source), a non-sugar source 1106 (e.g., a second ingredient source), a first element source 1108 (e.g., a third ingredient source), a second element source 1110 (e.g., a fourth ingredient source), and/or an Nth element source 1112 (e.g., an Nth ingredient source). In one example, the dispensing system 1100 has a plurality of outlet areas (e.g., reference numbers 1114, 1116, 1118, 1120, 1122, 1124, 1126, and/or 1128). In one example, the plurality of outlets areas has two types of outlets: a) a multiple outlet area (e.g., a first multiple outlet area 1114 and an Nth multiple outlet area 1116) and b) a single outlet area (e.g., a first single outlet area 1118, a second single outlet area 1120, a third single outlet area 1122, a fourth single outlet area 1124, a fifth single outlet area 1126, and/or an Nth single outlet area 1128). In one example, the multiple outlet areas (e.g., 1114 and 1116) are outlet areas where two or more ingredient sources are dispensed to the multiple outlet area. In another example, the single outlet areas are outlet areas where only one ingredient is dispensed at a time. In various examples, utilizing various links (e.g., reference numbers 1130, 1132, 1134, 1136, 1138, 1140, 1142, 1144, 1146, 1148, 1150, 1152, and/or 1154) a single ingredient may be dispensed to the single outlet areas (e.g., reference numbers 1118, 1120, 1122, 1124, 1126, and/or 1128) and/or two or more ingredients may be dispensed to the multiple outlet areas (e.g., reference numbers 1114 and 1116).

In one example, a system may include multiple fluids that can be sauces, syrups, flavors, concentrated beverages, concentrated ingredients, non-concentrated beverages, ingredients and/or other fluids and/or gases. In this example, the system may dispense one or more liquids and/or gas from a single dispensing point. For example, certain fluids can be dispensed together from a multi-flavor dispense head and mixed as they are dispensed into a cup, pitcher, and/or downstream into a mixing chamber. In addition, a single fluid can be dispensed on their own from a single dispense point or through a multiple-dispense point.

In another example, the system may use a CF Valve to pressurize the dispensing which has the benefit of being faster than traditional pump bottles or systems that utilize pumps and plumbing. In addition, the CF Valve system is safer for employees because there are fewer repetitive motion injuries (e.g., from reaching up and pumping down especially with viscous liquids that require significant force on the pump to operate). In addition, there is substantially less waste because the product is delivered in flexible packaging compared to standard bottles/jugs (the volume of waste and trips to the dumpster can be reduced by up to 60%). Further, the CF Valve dispensing system is substantially more accurate than manual pumps which can be over +/−20 percent off in dispensing the amount due to differences in how an employee pumps the bottle. In addition, the system can be +/−5 percent accurate dispensing the product. In addition, the system can be cleaned easier than existing pump-based systems. Further, some fluids can be concentrated which reduces space requirements for operations and storage. This also reduces the amount of changeover required because the material lasts longer.

In FIG. 11B, a dispensing system 1156 includes one or more pressure vessels that are utilized to control the flow of one or more elements. The dispensing system 1156 includes a housing 1158 (with one or more pressure vessels), a first syrup source 1160, a second syrup source 1162, an Nth syrup source 1164, a multiple flavor source 1166 (with a plurality of flavors 1168), and/or a dispensing area 1122 with dispensed products 1174 (from dispensing area 1172). In one example, more than one bag may be in the pressure vessel. For example, a first ingredient and a second ingredient may be delivered from a first pressure vessel and a high ratio (30:1; 60:1; 100:1; etc.) element may be mixed from a second pressure vessel with either sugared or sugar-free syrup from a third pressure vessel all mixed together at a dispensing point and/or a mixing chamber.

FIG. 11C shows a dispensing system 1176 including an order receiving device 1178, a controller 1180, a plurality of pressure vessel stacks 1182, a first pressure vessel stack 1184, a second pressure vessel stack 1186, a third pressure vessel stack 1188, a fourth pressure vessel stack 1190, an Nth pressure vessel stack 1192, and/or a dispensing device 1194 with a dispensing area 1196. In this example, the order receiving device 1178 may be a mobile computer and a stationary computing device. In one example, an order is entering into the order receiving device 1178 which is transmitted to the controller 1180. In this example, the controller determines one or more recipes for the order and transmits one or more control signals to one or more of the plurality of pressure vessel stacks 1182 which generates the order and delivers the order via one or more pathways (e.g., reference numbers 1198A, 1198B, 1198C, 1198D, and/or 1198E) to the dispensing device 1194 for dispensing into the dispensing area 1196. In various examples, the one or more of the pressure vessel stacks in the plurality of pressure vessel stacks 1182 may have any number of pressure vessels (e.g., 1, 2, 3, 4, 5, 6, 11, 8, 9, 10, 11, . . . , 100). In addition, each pressure vessel may contain one element and/or ingredient. Further, each pressure vessel may contain more than one element and/or ingredient. For example, the first pressure vessel stack 1184 may contain a first stack with only a first syrup. In another example, the first pressure vessel stack 1184 may contain 10 stacks with each stack containing a single different syrup in each stack. In another example, the first pressure vessel stack 1184 may contain 10 stacks with 5 of the stacks containing a single different syrup in each stack and 5 of the stacks containing at least two different syrups in each stack. In another example, the second pressure stack 1186 may contain 20 stacks with 4 of the stacks containing a single different flavor in each stack; 6 stacks containing two different flavors in each stack; 3 stacks containing 5 different flavors in each stack, 2 stacks containing 3 different flavors in each stack; and 5 stacks containing 12 different flavors in each stack.

FIG. 11D shows a dispensing system 1101 with a housing 1103, one or more pressurized vessels (1105 and 1105A), and/or one or more fittings 11011. In FIG. 8, a dispensing system 800 with a pressure vessel 802, a bag 804, a fitting 806, and outlet area 808, and/or a pressure input area 810 is shown. In one example, the bag 804 is elongated and not completely filled with ingredients. In another example, the bag 804 has an outlet in the center of one end and a longer thinner shape to fit in the cylindrical canister (e.g., pressure vessel 802). This allows for the optimization of the amount of fluid that can be put into the bag 804 and minimizes the labor required to exchange the bag 804 when emptied for a new bag. In one example, utilizing a rectangular bag with a cap/outlet on one corner can generate 30-40 percent wasted space inside of the pressure vessel 802. By utilizing a longer thinner shape and having the outlet near the center, the wasted space is reduced to 10-15 percent.

In FIG. 12, a dispensing device 1200 is shown. In one example, dispensing device 1200 includes a container 1202, a bag 1204, a bag outlet area 1206, a dispensing area 1208, and/or a container inlet area 1210.

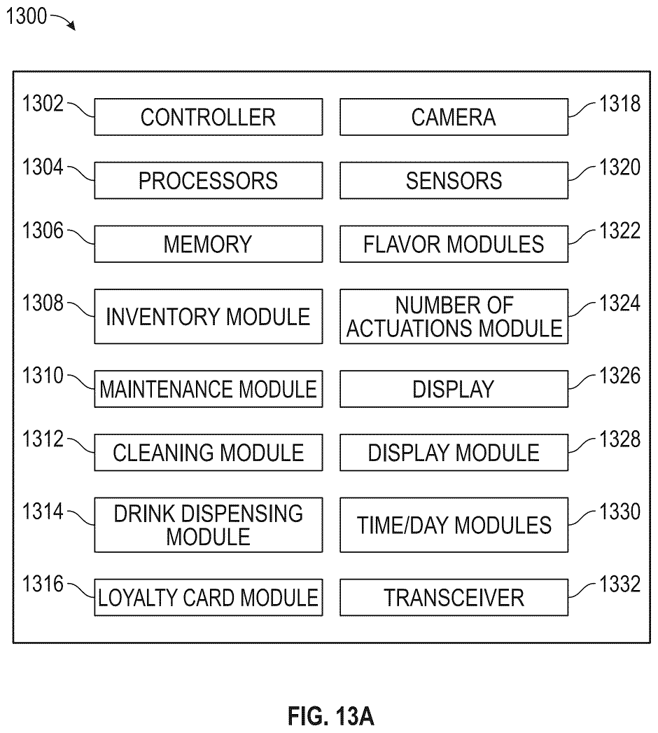

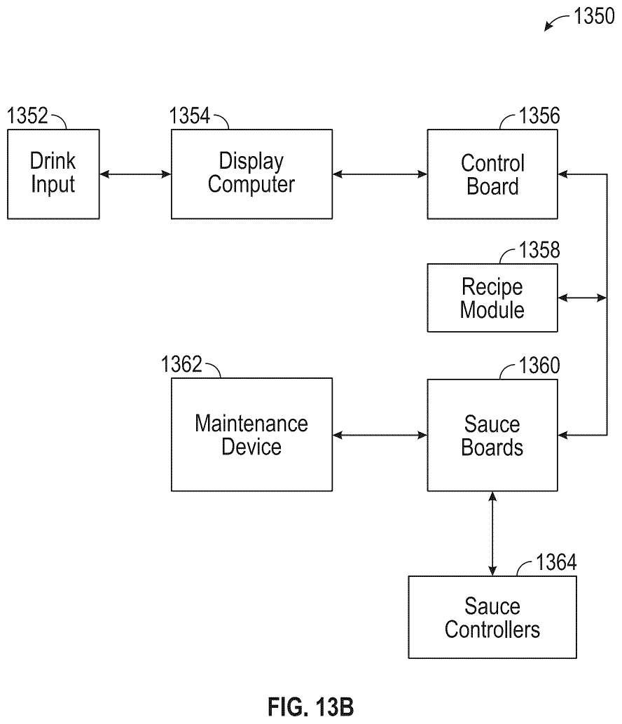

In FIGS. 13A-13B, illustrations of block diagrams are shown, according to various embodiments. In FIG. 13A, a block diagram is shown, according to one embodiment. A device 1300 may include a controller 1302, one or more processors 1304, one or more memories 1306, one or more inventory modules 1308, one or more maintenance modules 1310, one or more cleaning modules 1312, one or more drink dispensing modules 1314, one or more loyalty card modules 1316, one or more cameras 1318, one or more sensors 1320, one or more flavor modules 1322, one or more number of actuations modules 1324, one or more displays 1326, one or more display modules 1328, one or more time/day modules 1330, and/or one or more transceivers 1332 and/or a recipe module 1358 (see FIG. 13B).

In one example, the one or more inventory modules 1308 may be utilize to track one or more materials to be reordered. For example, material for creating a drink has reached a predetermined inventory level, therefore, the system automatically and/or via an approval function orders more of the material. In another example, one or more pressure vessel has been utilized a predetermined number of times, therefore, a maintenance request is issued and/or warning report generated via the one or more maintenance modules 1310. In another example, a predetermined number of drinks have been created which requires a cleaning procedure to be initiated via the one or more cleaning modules 1312. In another example, one or more drink dispensing modules 1314 may include one or more recipes for one or more drinks. In addition, the one or more loyalty card modules 1316 may be utilized to track a client's purchase and generate one or more rewards and/or discounts. In another example, the one or more cameras 1318 may be utilized to track system performance. In another example, the one or more sensors 1320 may be utilized to track the performance of one or more devices and/or fluid and/or elements. In addition, the one or more flavor modules 1322 may track data relating to one or more flavors. In addition, the one or more number of actuations modules 1324 may track the number of times a device is utilized. Further, the one or more displays 1326 may be utilized to display any data relating to this disclosure via the one or more display modules 1328. In another example, the one or more time/day modules 1330 may be utilized to track purchase and/or activity rate throughout the day. In addition, the one or more transceivers 1332 may transmit any data in this disclosure to a remote device, control center, and/or any computing device. In addition, the recipe module 1358 may include any data relating to any recipe.

In another example, syrup control and/or management can be enhanced because dumping and/or walk away can be tracked. For example, when a person buys a fountain drink that person may take a slip and if the taste is not correct that person may dump the contents of the container and refill with another flavor. This might indicate that the syrup ratio is out of range and/or another quality control issue. In addition, the person may just walk away and not purchase anything which could be an indication that the syrup ratio is out of range and/or another quality control issue.

FIG. 13B shows a drink delivery system 1350 including a drink input device 1352, a display computer 1354, a control board 1356, a recipe module 1358, a sauce board 1360, a maintenance device 1362, and/or a sauce controller(s) 1364. In one example, an order is input via a touch screen (e.g., 1352) which is then displayed on a computer (e.g., 1354). Further, a control board 1356 communicates with the recipe module 1358 to determine which control signals to transmit to the sauce board 1360. The sauce board 1360 transmits data to the sauce controller(s) 1364 which transmits signals to various elements to produce the drink. In addition, the sauce board 1360 transmits data to the maintenance device 1362 to track data and/or initiate any maintenance activities (e.g., cleaning, repairing, etc.).

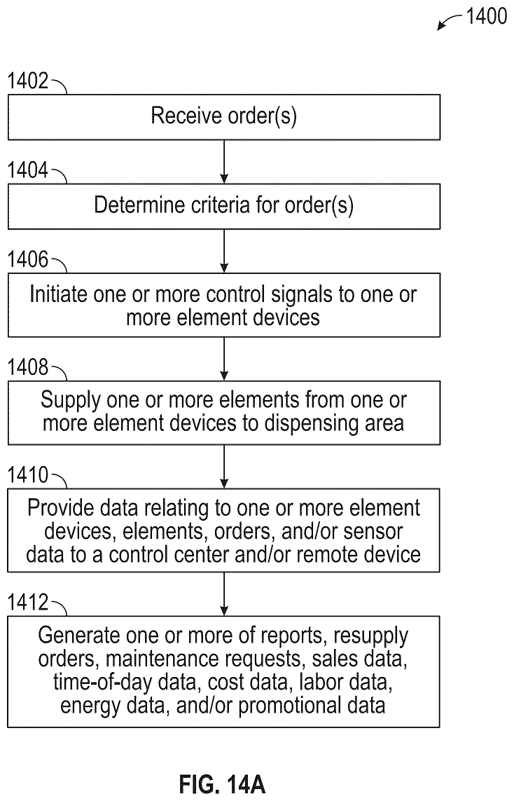

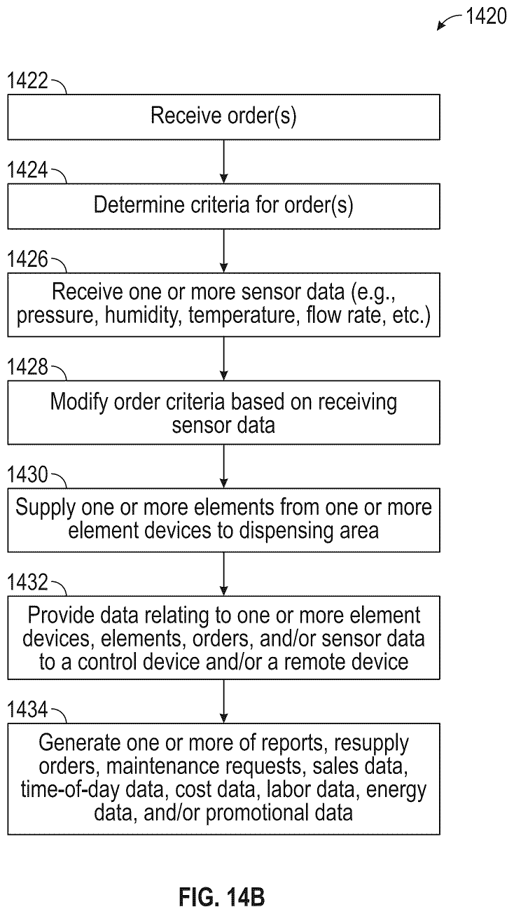

In FIGS. 14A-14C, illustrations of flowcharts are shown, according to various embodiments. In FIG. 14A, a method 1400 may include receiving order(s) (step 1402). The method 1400 may include determining criteria for the order(s) (step 1404). The method 1400 may include initiating one or more control signals to one or more element devices (step 1406). The method 1400 may include supplying one or more elements from one or more element devices to a dispensing area (step 1408). The method 1400 may include providing data relating to one or more element devices, elements, orders, and/or sensor data to a control center and/or remote device (step 1410). The method 1400 may include generating one or more reports, resupply orders, maintenance requests, sales data, time-of-day data, cost data, labor data, energy data, and/or promotional data to one or more of a control device, computing device, and/or remote computing device (step 1412).

In FIG. 14B, a method 1420 may include receiving order(s) (step 1422). The method 1420 may include determining criteria for the order(s) (step 1424). The method 1420 may include receiving one or more sensor data (e.g., pressure, humidity, temperature, flowrate, etc.) (step 1426). The method 1420 may include modifying order criteria based on the received sensor data (step 1428). The method 1420 may include initiating one or more control signals to one or more element devices (see FIG. 14A—step 1406). The method 1420 may include supplying one or more elements from one or more element devices to a dispensing area (step 1430). The method 1420 may include providing data relating to one or more element devices, elements, orders, and/or sensor data to a control center and/or remote device (step 1432). The method 1420 may include generating one or more reports, resupply orders, maintenance requests, sales data, time-of-day data, cost data, labor data, energy data, and/or promotional data to one or more of a control device, computing device, and/or remote computing device (step 1434).

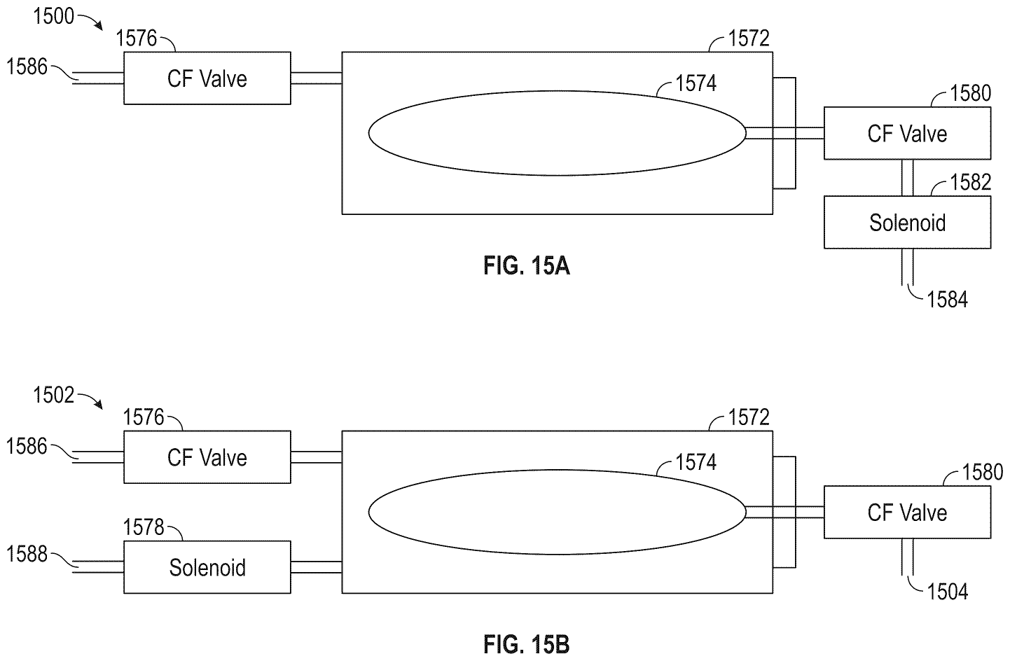

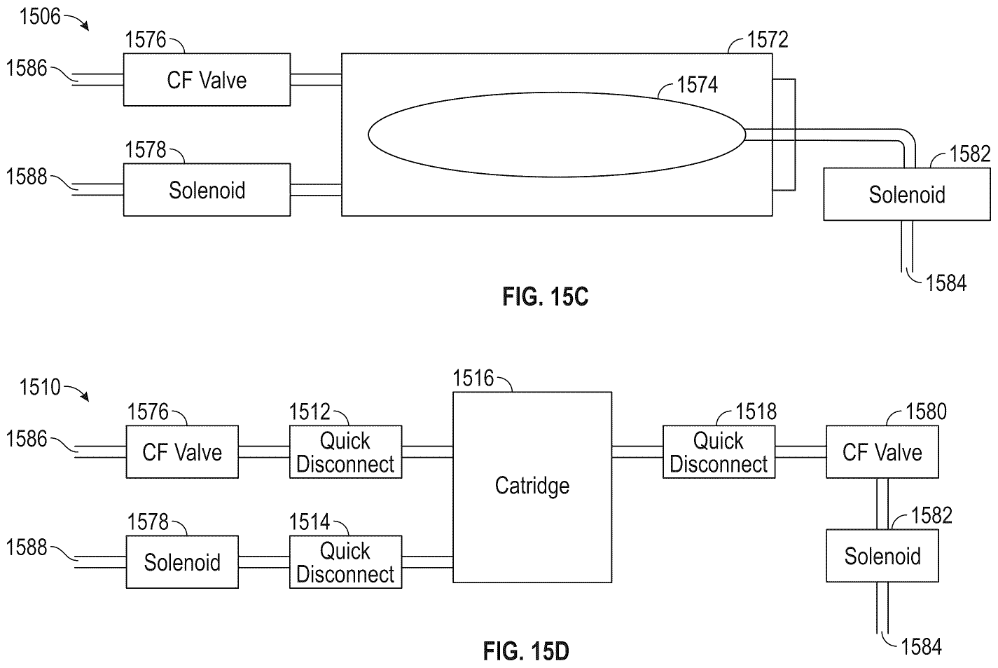

In FIGS. 15A-15D, illustrations of the pressurized container dispensing system are shown, according to various embodiments. FIG. 15A shows a pressurized dispensing system 1500 including the pressure vessel 1572, the flexible bag 1574, the first CF Valve 1576 with a solenoid (e.g., a CFiVe valve), the second CF Valve 1580, the third solenoid 682, the outlet area 684 (e.g., dispensing area), and/or the pressure input area 686. In this example, the dispensing system 1500 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 27 PSI) and the second CF Valve 680 on the outlet of the canister operates at an operating pressure of Y (e.g., 15 PSI). In this example, the operating pressure of Y is less than the operating pressure of X. In one example, the first CF Valve 676 with a solenoid is opened and the canister is filled to the operating pressure X (e.g., 27 PSI) and as soon as the pressure in the pressure vessel 672 exceeds the operating pressure Y (e.g., 15 PSI) the second CF Valve 680 will open and dispense one or more elements (e.g., fluids, gas, etc.) from the flexible bag 674. In various examples, the second CF Valve 680 may have a throttle pin and/or no throttle pin depending on the flow rate to be achieved by the one or more elements. In another example, the first CF Valve 676 with a solenoid will open for 0.83 seconds to dispense 0.42 ounces of a fluid at 27 PSI, once the pressure vessel 672 fluid (e.g., fluid in bag) exceeds 15 PSI the second CF Valve 680 will open and dispense the one or more elements.

FIG. 15B shows a pressurized dispensing system 1502 including includes the pressure vessel 672, the flexible bag 674, the first CF Valve 676 with a solenoid (e.g., a CFiVe valve), the second solenoid 678, the second CF Valve 680, the outlet area 684 (e.g., dispensing area), the pressure input area 686, and/or the pressure outlet area 688. In this example, the dispensing system 1502 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 25 PSI) and the second CF Valve 680 on the outlet of the canister operates at an operating pressure of Y (e.g., 13 PSI). In this example, the operating pressure of Y is less than the operating pressure of X. In addition, the second solenoid 678 acts to depressurize the pressure vessel 672 when the dispensing operation is completed. In one example, the first CF Valve 676 with a solenoid is opened and the canister is filled to the operating pressure X (e.g., 25 PSI) and as soon as the pressure in the pressure vessel 672 exceeds the operating pressure Y (e.g., 13 PSI) the second CF Valve 680 will open and dispense one or more elements (e.g., fluids, gas, etc.) from the flexible bag 674. In this example, when the appropriate amount of the one or more elements is dispensed, the second solenoid 678 will open to partially relieve the pressure from the pressure vessel 672 to under the threshold of the second CF Valve 680 operating pressure of Y. In various examples, the second CF Valve 680 may have a throttle pin and/or no throttle pin depending on the flow rate to be achieved by the one or more elements. In another example, the second solenoid 678 may be controlled with a set time to depressurize and/or with a pressure sensor to depressurize to a set pressure. There are many benefits to this dispensing system 1502. For example, there are no electronics or electrical connections on the lid/cover of the pressure vessel 672 (which must be removed to replace the flexible bag 674 and to be cleaned). In another example, the first CF Valve 676 with a solenoid will open for 0.75 seconds to dispense 0.5 ounces of a fluid at 25 PSI, once the pressure vessel 672 fluid (e.g., fluid in bag) exceeds 13 PSI the second CF Valve 680 will open and dispense the one or more elements. Once the first CF Valve 676 with a solenoid closes, the second solenoid 678 will open for 0.6 seconds to relieve the pressure of fluid (e.g., fluid outside of the flexible bag 674) in the pressure vessel 672 to 11 PSI and the second CF Valve 680 will close which stops the dispensing of the one or more elements (e.g., liquid, gas, etc.). In another example, the second solenoid 678 can be controlled with a pressure sensor so that the second solenoid 678 opens and then closes when the pressure in the pressure vessel 672 reaches a targeted closing pressure (e.g., 11 PSI in the above-referenced example).

In FIG. 15C. a dispensing system 1506 includes the pressure vessel 672, the flexible bag 674, the first CF Valve 676 with a solenoid (e.g., a CFiVe valve), the second solenoid 678, the third solenoid 682, the outlet area 684 (e.g., dispensing area), the pressure input area 686, and/or the pressure outlet area 688. In this example, the dispensing system 1506 has no electronic components on the outlet of the canister (e.g., pressure vessel 672), which reduces the cost of the equipment, reduces cleaning requirements and cleaning time, and/or reduces the cost of installation, routine operations, and maintenance. In this example, the first CF Valve 676 with a solenoid pressurizes the pressure vessel 672 and is controlled by the inbound solenoid at an operating pressure of X (e.g., 28 PSI) and the outlet of the canister operates at an operating pressure of Y (e.g., 16 PSI). In this example, the operating pressure of Y is less than the operating pressure of X. In addition, the second solenoid 678 acts to depressurize the pressure vessel 672 when the dispensing operation is completed. In one example, the first CF Valve 676 with a solenoid is opened and the canister is filled to the operating pressure X (e.g., 28 PSI) and as soon as the pressure in the pressure vessel 672 exceeds the operating pressure Y (e.g., 16 PSI) the third solenoid 682 will open and dispense one or more elements (e.g., fluids, gas, etc.) from the flexible bag 674. In this example, when the appropriate amount of the one or more elements is dispensed, the second solenoid 678 will open to partially relieve the pressure from the pressure vessel 672 to under the threshold operating pressure of Y. In another example, the second solenoid 678 may be controlled with a set time to depressurize and/or with a pressure sensor to depressurize to a set pressure. There are many benefits to this dispensing system 1506. For example, there are no electronics or electrical connections on the lid/cover of the pressure vessel 1572 (which must be removed to replace the flexible bag 1574 and to be cleaned). In another example, the first CF Valve 1576 with a solenoid will open for 0.63 seconds to dispense 0.75 ounces of a fluid at 28 PSI, once the pressure vessel 1572 fluid (e.g., fluid in bag) exceeds 16 PSI the third solenoid 1582 will open and dispense the one or more elements. Once the first CF Valve 1576 with a solenoid closes, the second solenoid 1578 will open for 0.9 seconds to relieve the pressure of fluid (e.g., fluid outside of the flexible bag 1574) in the pressure vessel 1572 to 15 PSI and the second CF Valve 1580 will close which stops the dispensing of the one or more elements (e.g., liquid, gas, etc.). In another example, the second solenoid 1578 can be controlled with a pressure sensor so that the second solenoid 1578 opens and then closes when the pressure in the pressure vessel 1572 reaches a targeted closing pressure (e.g., 15 PSI in the above-referenced example).

In FIG. 15D. a dispensing system 1510 includes a first disconnect device 1512, a second disconnect device 1515, a cartridge 1516 (e.g., filled with flavors, liquids, elements, ingredients, etc.), a third disconnect device 1518, the first CF Valve 1576 with a solenoid (e.g., a CFiVe valve), the second solenoid 1578, the second CF Valve 1580, the third solenoid 1582, the outlet area 1584 (e.g., dispensing area), the pressure input area 1586, and/or the pressure outlet area 1588. In this example, the dispensing system 1510 has no electronic components on the outlet of the canister (e.g., pressure vessel 1572), which reduces the cost of the equipment, reduces cleaning requirements and cleaning time, and/or reduces the cost of installation, routine operations, and maintenance. In this example, the first CF Valve 1576 with a solenoid pressurizes the cartridge 1516 and is controlled by the inbound solenoid at an operating pressure of X (e.g., 27 PSI) and the second CF Valve 1580 on the outlet of the canister operates at an operating pressure of Y (e.g., 15 PSI). In this example, the operating pressure of Y is less than the operating pressure of X. In addition, the second solenoid 1578 acts to depressurize the cartridge 1516 when the dispensing operation is completed. In one example, the first CF Valve 1576 with a solenoid is opened and the cartridge 1516 is filled and/or pressure applied to the cartridge to the operating pressure X (e.g., 27 PSI) and as soon as the pressure exceeds the operating pressure Y (e.g., 15 PSI) the second CF Valve 1580 will open and dispense one or more elements (e.g., fluids, gas, etc.) from the cartridge 1516. In this example, when the appropriate amount of the one or more elements is dispensed, the second solenoid 678 will open to partially relieve the pressure from the cartridge 1516 to under the threshold of the second CF Valve 1580 operating pressure of Y. In various examples, the second CF Valve 680 may have a throttle pin and/or no throttle pin depending on the flow rate to be achieved by the one or more elements. In another example, the second solenoid 1578 may be controlled with a set time to depressurize and/or with a pressure sensor to depressurize to a set pressure. There are many benefits to this dispensing system 1510. For example, there are no electronics or electrical connections on the lid/cover of the pressure vessel 1572 (which must be removed to replace the flexible bag 1574 and to be cleaned). In another example, the first CF Valve 1576 with a solenoid will open for 0.83 seconds to dispense 0.42 ounces of a fluid at 27 PSI, once the cartridge 1516 fluid (e.g., fluid in cartridge) exceeds 15 PSI the second CF Valve 1580 will open and dispense the one or more elements. Once the first CF Valve 1576 with a solenoid closes, the second solenoid 1578 will open for 0.7 seconds to relieve the pressure on the cartridge 1516 to 12 PSI and the second CF Valve 1580 will close which stops the dispensing of the one or more elements (e.g., liquid, gas, etc.). In another example, the second solenoid 1578 can be controlled with a pressure sensor so that the second solenoid 1578 opens and then closes when the pressure in the cartridge 1516 reaches a targeted closing pressure (e.g., 12 PSI in the above-referenced example).

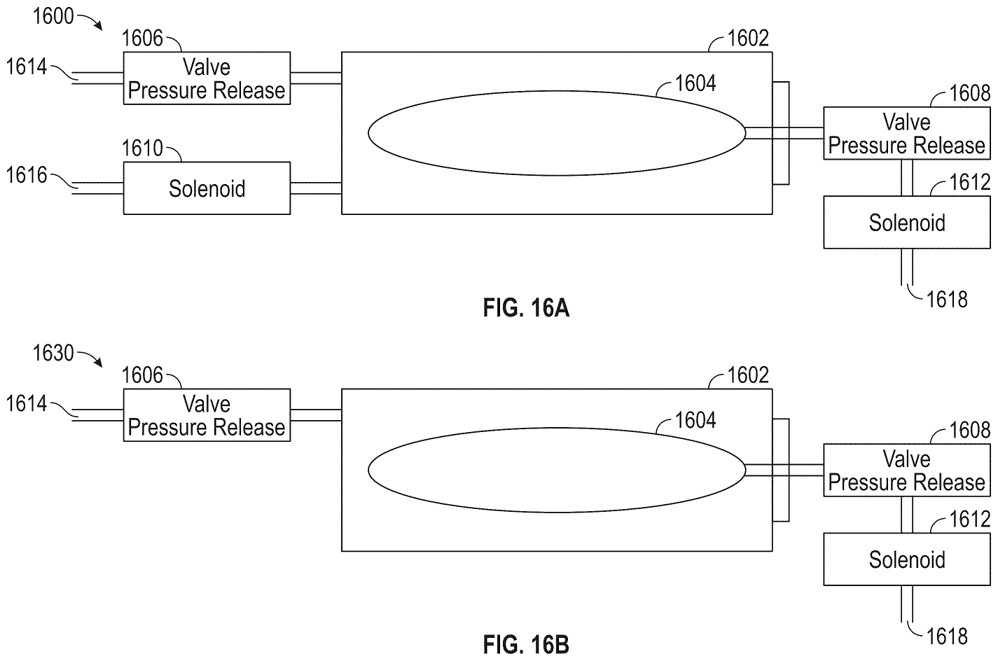

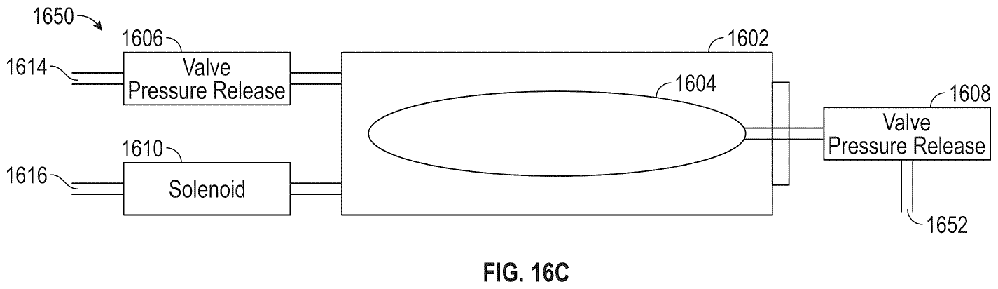

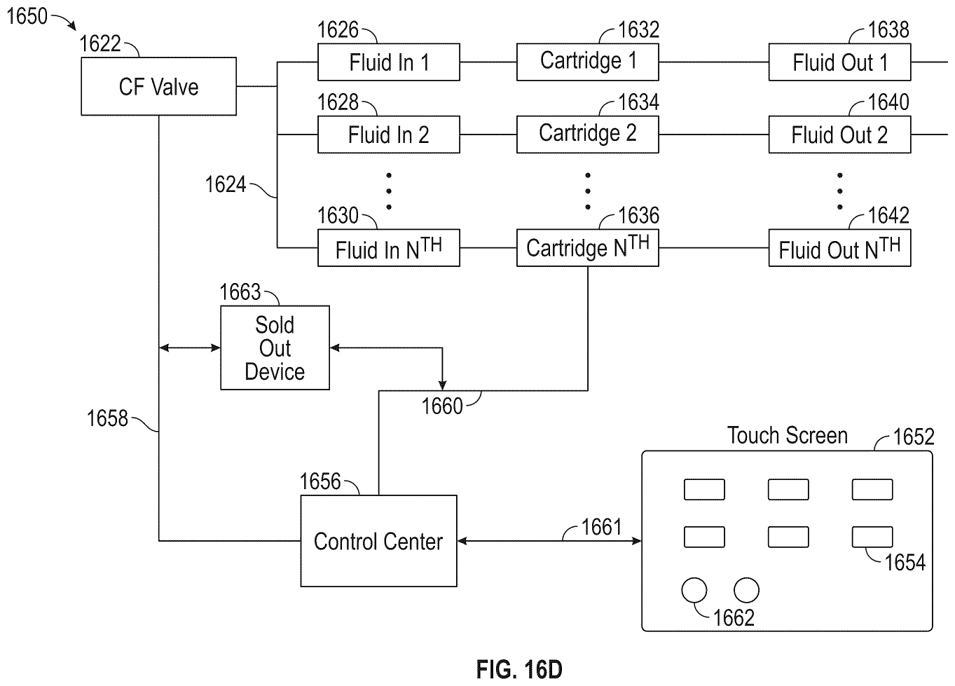

In FIG. 16A, a dispensing system 1600 includes a pressure vessel 1602, a flexible bag 1604, a first pressure release valve 1606, a first solenoid 1610, a second pressure release valve 1608, a second solenoid 1612, an outlet area 1618 (e.g., dispensing area), a pressure input area 1614, and/or a pressure outlet area 1616. In FIG. 16B, a dispensing system 1630 includes the pressure vessel 1602, the flexible bag 1604, the first pressure release valve 1606, the second pressure release valve 1608, the second solenoid 1612 (first solenoid in this example), the outlet area 1618 (e.g., dispensing area), and/or the pressure input area 1614. In FIG. 16C, a dispensing system 1650 includes the pressure vessel 1602, the flexible bag 1604, the first pressure release valve 1606, the first solenoid 1610, the second pressure release valve 1608, the outlet area 1618 (e.g., dispensing area), the pressure input area 1614, and/or the pressure outlet area 1616.

In FIG. 16D, the single CF Valve 1622 is providing a pressure function to the manifold 1624 of cartridges and/or pressure vessels. For example, the manifold 1624 is providing the first fluid flow 1626 to the first cartridge 1632 which generates the first fluid out 1638. In addition, the manifold 1624 being fed by the CF Valve 1622 provides the second fluid flow 1628 to the second cartridge 1634 which generates the second fluid out 1640. Further, the manifold 1624 provides the Nth fluid flow 1630 to the Nth cartridge 1636 which generates the Nth fluid out 1642. In addition, the system may include a touch screen 1652 with one or more buttons 1654 or knobs 1662. The touch screen 1652 may communicate with a control center 1656 to transmit one or more command signals to one or more cartridges and/or pressuring vessels, and/or CF Valves 1622 via one or more communication links (e.g., 1658, 1660, and 1661). In addition, a sold-out device 1663 may be utilized.

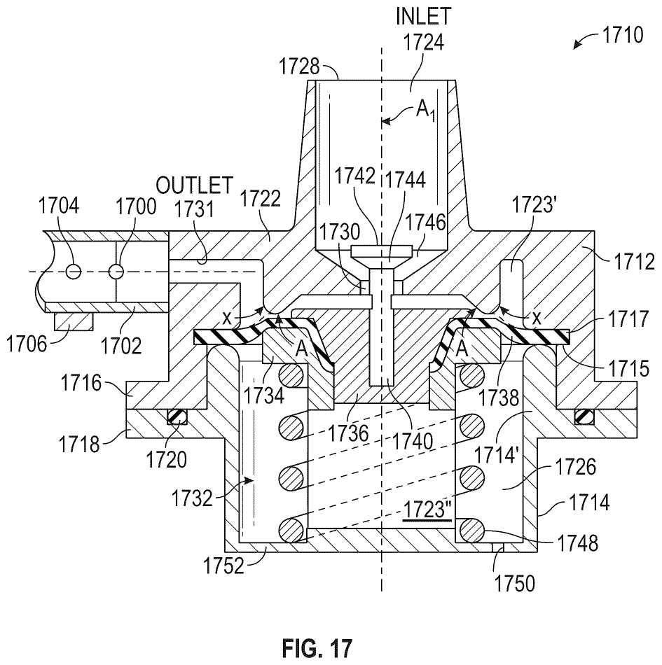

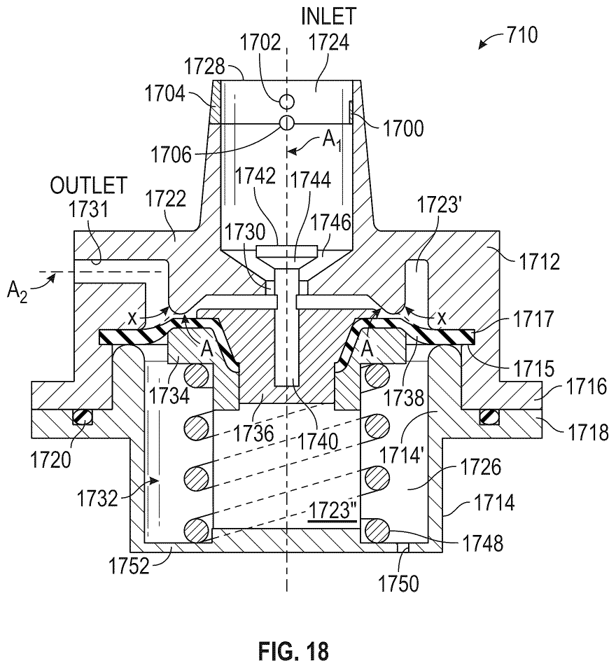

FIGS. 17-18 are illustrations of a CF Valve, according to various embodiments. With reference to FIGS. 17-18, a regulating valve in accordance with the present disclosure is generally depicted at 1710. The valve includes an outer housing having a cap 1712 joined to a cup-shaped base 1714 at mating exterior flanges 1716, 1718.

The housing is internally subdivided by a barrier wall 1722 into a head section 1724 and a base section 1726. An inlet 1728 in the cap 1712 is adapted to be connected to a fluid supply (not shown) having a pressure that can vary from below to above a threshold level. The inlet 1728 and a central port 1730 in the barrier wall 1722 are preferably aligned coaxially with a central axis A1 of the valve. An outlet port 1731 is provided in the cap 1712, and may be aligned on a second axis A2 transverse to the first axis A1. Although the axis A2 is shown at 90° with respect to axis A1, it will be understood that axis A2 may be oriented at other angles with respect to axis A1 in order to suit various applications of the valve.

A modulating assembly 1732 internally subdivides the base section into a fluid chamber 1723′ segregated from a spring chamber 1723″. The modulating assembly serves to prevent fluid flow through the valve when the fluid pressure at the inlet 1728 is below the threshold pressure. When the fluid pressure at the inlet exceeds the threshold pressure, the modulating assembly serves to accommodate fluid flow from the head section 1724 through port 1730 into fluid chamber 1723′ and from there through outlet port 1731 at a substantially constant outlet pressure and flow rate. Either the outlet port 1731 or a downstream orifice or flow restrictor (not shown) serves to develop a back pressure in fluid chamber 1723′.

The modulating assembly 1732 includes a piston comprised of a hollow shell 1734 and a central plug 1736. The piston is supported for movement in opposite directions along axis A1 by a flexible annular diaphragm 1738. The inner periphery of the diaphragm is captured between the shell 1734 and plug 1736. The cup shaped base 1714 has a cylindrical wall segment 1714′ received within the cap 1712. The outer periphery of the diaphragm is captured between an upper rim 1715 of the wall segment 1714′ and an inwardly projecting interior ledge 1720 on the cap. The outer periphery of the diaphragm thus serves as an effective seal between the cap 1712 and base 1714.

A stem 1740 on the piston plug 1736 projects through the port 1730 into the head section 1724. An enlarged head 1742 on the stem has a tapered underside 1744 that coacts with a tapered surface 1746 of the barrier wall to modulate the size of the flow path through the port 1730 as an inverse function of the varying fluid pressure in the input section, with the result being to deliver fluid to the outlet 1731 at a substantially constant pressure and flow rate.

A compression spring 1748 in the spring chamber 1723″ is captured between an underside surface of shell 1734 and the bottom wall 1752 of the housing base 1714. The spring urges the modulating assembly 1732 towards the barrier wall 1722. When the fluid inlet pressure is below the threshold pressure, spring 1748 serves to urge the diaphragm 1738 against a sealing ring 1749 on the underside of the barrier wall 1722, thus preventing fluid through flow from the head section 1724 via port 1730 and fluid chamber 1723′ to the outlet 1731. As the fluid inlet pressure exceeds the threshold pressure, the resilient closure force of spring 1748 is overcome, allowing the modulating assembly to move away from the sealing ring 1749, and allowing the modulating function of the coacting tapered surfaces 1744, 1746 to commence. An opening 1750 in the bottom wall 1752 serves to vent the volume beneath diaphragm 1738 to the surrounding atmosphere.

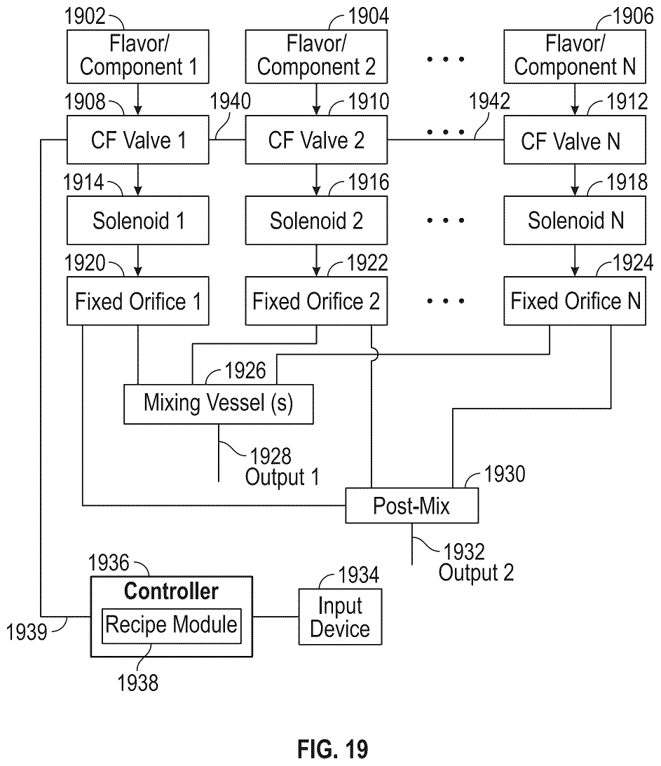

In FIG. 19, an illustration of an exemplary embodiment of a liquid delivery system is shown, according to one embodiment. FIG. 19 shows a dispensing device 1900 including a first flavor/component 1902, a second flavor/component 1904, an Nth flavor/component 1906, a first CF Valve 1908 (e.g., a CF Valve only, a CF Valve with a Solenoid (e.g., CFIVe), and/or any other type of valve in this disclosure), a second CF Valve 19190, an Nth CF Valve 1912, a first solenoid 19194, a second solenoid 1916, an Nth solenoid 1918, a first fixed orifice 1920, a second fixed orifice 1922, an Nth fixed orifice 1924, a mixing vessel(s) 1926, an output of the mixing vessel(s) 1928, a post-mix area 1930, an output of the post-mix area 1932, an input device 1934, and/or a controller 1936 with or without a recipe module 1938.

In one example, the dispensing device is a recipe based system that is driven from a bank of two or more CFiVes (e.g., CF Valve and a Solenoid) that each represent a single fluid (liquid or gas) which then mix together to make a designated recipe. These can be pre-mix or post-mix (meaning they can mix in a manifold or vessel prior to dispense or mix at atmosphere at the point of dispense). In one example of a CF Valve application, the controlling orifice or flow insert after the outlet of the valve is changed in order to increase or decrease the total flow rate or amount poured. In contrast, the dispensing device 1900 shown in FIG. 19, the flow rate is fixed with an orifice and the amount dispensed or mixed into the recipe is based on the “on time” designated in the recipe.

For example, if a CFiVe with a specific orifice and a specific fluid flows at 1 ounce per second is utilized but the recipe only calls for 0.50 ounces, then the controller for the CFiVes will turn the CFiVe on and off again at a 50% duty cycle rate during a one second time slot to achieve the 0.50 ounces per second. Conversely, if the recipe calls for 2 ounces the controller will turn the CFiVe on and leave it actuated/open for 2 seconds to get the desired 2 ounces. The same ingredient can be dosed in different amounts for different recipes based on the “time on” dictated by the controller.

In legacy dispensers that use PRVs, ceramics or other types of flow control valves this level of control is not possible—meaning that if you want several different flow rates/amounts with the same ingredient you may require several separate valves for each flow rate imagined.

In this example, the system, the controller, and/or computer for the system has recipes (which are either entered into the equipment via flash drive, IOT download, manually, etc.) and there is a “library” of ingredients and flow rates per second for each ingredient through the CFiVe and the orifice. The system controller can turn on and off the various CFiVes for each ingredient for the allotted amount of time during the pour in order to achieve the targeted amount of each ingredient for that particular recipe. The system can be updated with additional ingredients and/or additional recipes.

The benefits of this system are that there is no need to visit the store/restaurant/equipment in order to change orifices to update flow rates. With a simple recipe update via internet download, flash drive or manual entry—the system can now run that recipe (flow rate/quantity) for each ingredient. Furthermore, if new ingredients are introduced, still there is no need for a service visit to the equipment as the information for that new ingredient is updated in the system and the system can use that ingredient in the updated recipes.

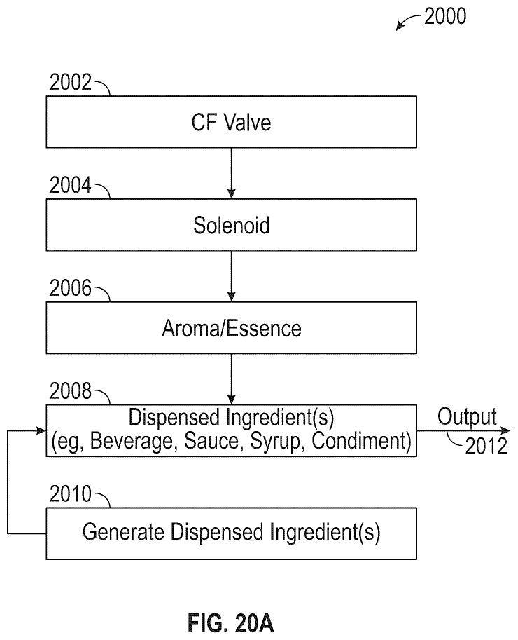

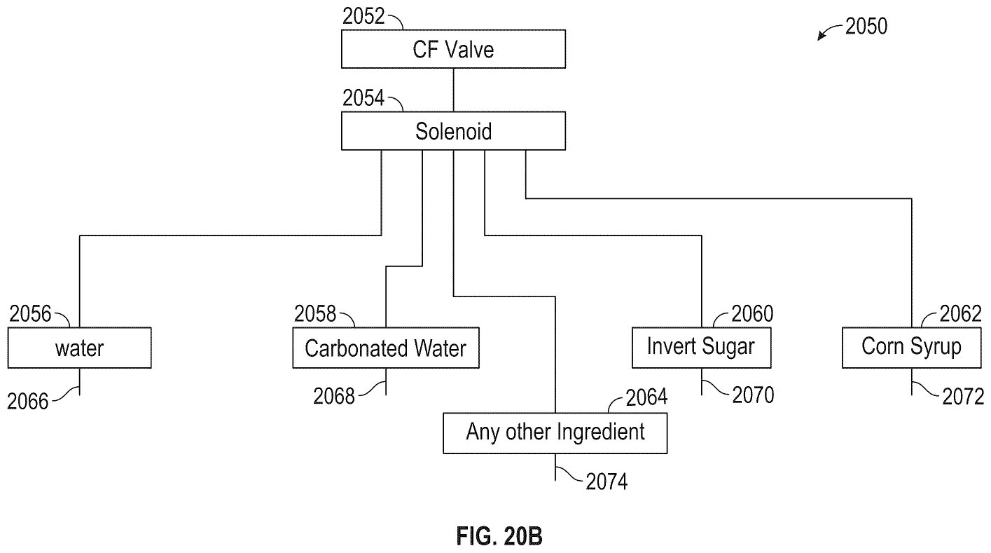

In FIGS. 20A-20B, illustrations depicting various dispensing functions are shown, according to various embodiments. FIG. 20A shows a dispensing device 2000 with two parts. The first part includes a CF Valve 2002, a solenoid 2004, and an aroma/essence element 2006. The second part includes an area where dispensed ingredients are generated 2010 (e.g., coffee machine, soda machine, juice machine, etc.) which are then transported to an injection area 2008 where the aroma/essence element 2006 is injected into the dispensed ingredients and outputted to an output area 2012.

In this system shown in FIG. 20A, a CF Valve is used to provide a dispense system for a flavor shot or aroma/essence into a dispensed ingredient (beverage, sauce, syrup, condiment). One CF Valve is controlling the essence or highly concentrated flavor that will be dispensed at several dispense points into various drink concentrates or food ingredients such as sauces, syrups or condiments.

The benefit of this system shown in FIG. 20A is that the essence or concentrated flavor will not lose its efficacy over time because it is kept in its purest form. For example, when mixed with syrups, sugar, sweetener and/or water, or other ingredients, the essence or concentrated flavor will become impure (e.g., contaminated) and the flavor and/or smell/essence will be reduced, which results in degraded beverage dispensing experiences.

In various examples, the system for the flavor dispenser can be a pressure dispensing system or a pump or atomizer to deliver the essence or concentrate flavor to the point of dispense.

FIG. 20B shows a dispensing system 2050 including a CF Valve 2052, a solenoid 2054, a water dispenser 2056, a carbonated water dispenser 2058, an invert sugar dispenser 2060, a corn syrup dispenser 2062, and/or any other ingredient dispenser 2064. In this example, the CF Valve 2052 maintains the pressure and/or flow rate for each and every dispenser (e.g., the water dispenser 2056, the carbonated water dispenser 2058, the invert sugar dispenser 2060, the corn syrup dispenser 2062, and/or the any other ingredient dispenser 2064) to a water outlet 2066, a carbonated water outlet 2068, an invert sugar outlet 2070, a corn syrup outlet 2072, and/or any other ingredient outlet 2074.

Furthermore, in this system shown in FIG. 20B, a single CF Valve can serve multiple dispensing heads for water, carb water, invert sugar, HF corn syrup, or any other ingredient. In this example, there is no need for multiple CF Valves at each point of dispense. So for example, in a carbonated drink machine there can be a single CF Valve may control the pressure and flow rates from one or more dispense points where the flavors, syrups, inclusions are mixed. In another example, one CF Valve can control invert sugar to multiple dispense point to be mixed with flavors, syrups and water. In another example, one CF Valve can control a condiment or sauce to be dispensed from one or more dispense points to be combined with other flavors, gasses, essences (example one source of Catsup can be mixed at one point of dispense with sriracha, and at another point be mixed with tabasco, and at another served plain).

In this system shown in FIG. 20B, the benefit includes space savings and costs savings by utilizing one CF Valve to feed multiple points of dispense. This savings at the point of dispense allows for more flavors/dispense points to be fit into the same footprint making the dispensing equipment more effective for the user and store owner.

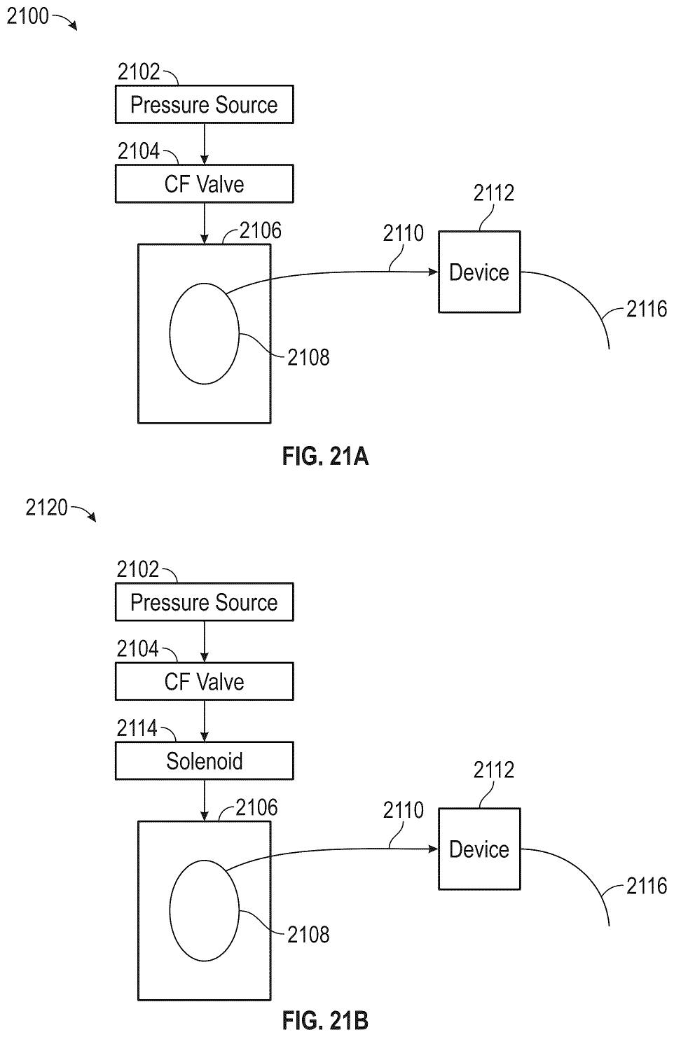

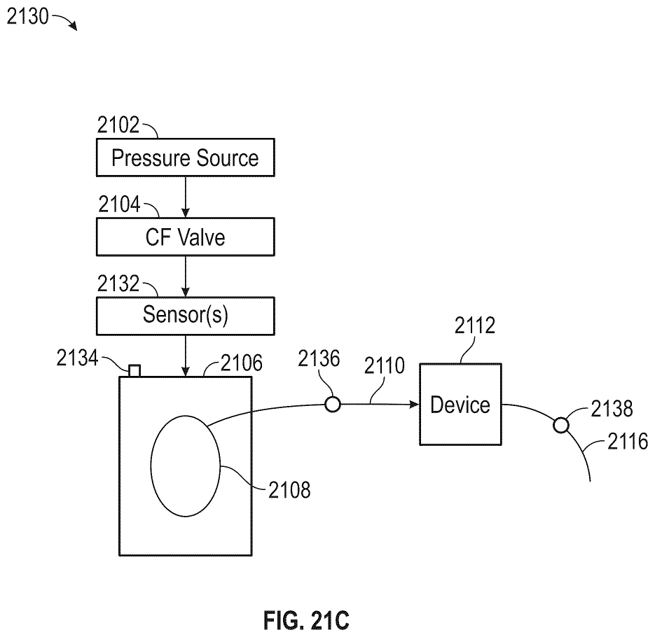

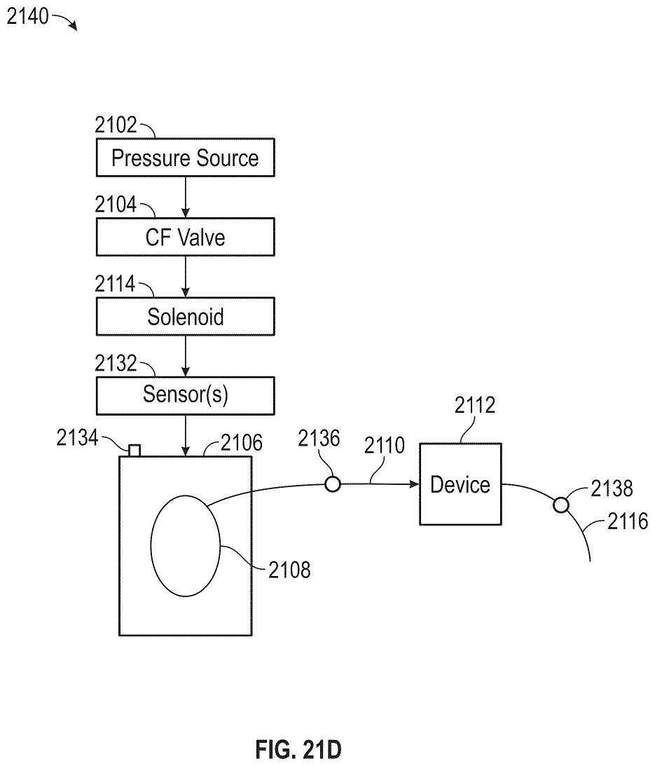

In FIGS. 21A-21D, illustrations of an exemplary embodiment of a cleaning system are shown, according to one embodiment. FIG. 21A shows a cleaning system 2100, which includes a pressure source 2102, a CF Valve 2104, a container 2106, a bag 2108, a bag outlet line 2110, a device 2112, and a device outlet line 2116. In this example, the CF Valve 2104 is a non-electric CF Valve.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 2106 of the input fluid (e.g., 7.5 PSI, 14 PSI, 21 PSI, 29 PSI, etc.) where that pressure will then act on the flexible package 2108 which contains the fluid (and/or cleaning element and/or ingredients (e.g., cleaner, sanitizer, etc.) and the fluid will be pushed through the flexible package 108 to the device 112 (and/or outlet).

The benefits of the cleaning system 2100 are that no pumps or plumbing or flow meters or connections are required to dispense any viscosity and/or any flow rate.

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

FIG. 21B shows a cleaning system 2120, which includes the pressure source 2102, the CF Valve 2104, the container 2106, the bag 2108, the bag outlet line 2110, the device 2112, the device outlet line 2116 and a solenoid 2114. In this example, the CF Valve 2104 is an electric CF Valve.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 2106 of the input fluid (e.g., 5.0 PSI, 10 PSI, 15 PSI, 20 PSI, etc.) where that pressure will then act on the flexible package 108 which contains the fluid (and/or cleaning element and/or ingredients (e.g., cleaner, sanitizer, etc.) and the fluid will be pushed through the flexible package 2108 to the device 2112 (and/or outlet).

The benefits of the cleaning system 2100 are that no pumps or plumbing or flow meters or connections are required to dispense any viscosity and/or any flow rate.

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

FIG. 21C shows a cleaning system 2130, which includes the pressure source 2102, the CF Valve 2104, the container 2106, the bag 2108, the bag outlet line 2110, the device 2112, the device outlet line 2116, one or more sensors 2132, a cleaning outlet line sensor 2136, a device outlet line sensor 22138, and a pressure relief device 2134. In this example, the CF Valve 2104 is a non-electric CF Valve.

In one example, the one or more sensors 2132 may determine any characteristic of the pressure medium and based on the one or more determined medium characteristic modify any characteristic of the CF Valve 2104, the bag 2108, the bag outlet line 2110, and/or any other system function and/or characteristic. In another example, the cleaning outlet line sensor 2136 may determine any characteristic of the medium in the bag outlet line 2110 and based on the one or more determined medium characteristic modify any characteristic of the CF Valve 2104, the bag 2108, the bag outlet line 2110, and/or any other system function and/or characteristic. In another example, the device outlet line sensor 2138 may determine any characteristic of the medium in the device outlet line 2116 and based on the one or more determined medium characteristic modify any characteristic of the CF Valve 2104, the bag 2108, the bag outlet line 2110, and/or any other system function and/or characteristic.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 2106 of the input fluid (e.g., 3.0 PSI, 9.0 PSI, 13.0 PSI, 18.0 PSI, etc.) where that pressure will then act on the bag 108 which contains the fluid (and/or cleaning element and/or ingredients (e.g., cleaner, sanitizer, etc.) and the fluid will be pushed through the flexible package 2108 to the device 2112 (and/or outlet).

The benefits of the cleaning system 2100 are that no pumps or plumbing or flow meters or connections are required to dispense any viscosity and/or any flow rate.

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

FIG. 21D shows a cleaning system 2140, which includes the pressure source 102, the CF Valve 2104, the container 2106, the bag 2108, the bag outlet line 2110, the device 2112, the device outlet line 2116, one or more sensors 2132, the cleaning outlet line sensor 2136, the device outlet line sensor 2138, the pressure relief device 2134, and the solenoid 2114. In this example, the CF Valve 2104 is an electric CF Valve.

In one example, the one or more sensors 2132 may determine any characteristic of the pressure medium and based on the one or more determined medium characteristic modify any characteristic of the CF Valve 2104, the bag 2108, the bag outlet line 2110, and/or any other system function and/or characteristic. In another example, the cleaning outlet line sensor 2136 may determine any characteristic of the medium in the bag outlet line 2110 and based on the one or more determined medium characteristic modify any characteristic of the CF Valve 2104, the bag 2108, the bag outlet line 2110, and/or any other system function and/or characteristic. In another example, the device outlet line sensor 2138 may determine any characteristic of the medium in the device outlet line 2116 and based on the one or more determined medium characteristic modify any characteristic of the CF Valve 2104, the bag 2108, the bag outlet line 2110, and/or any other system function and/or characteristic.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 2106 of the input fluid (e.g., 10.0 PSI, 25.0 PSI, 45.0 PSI, 60.0 PSI, etc.) where that pressure will then act on the bag 2108 which contains the fluid (and/or cleaning element and/or ingredients (e.g., cleaner, sanitizer, etc.) and the fluid will be pushed through the flexible package 2108 to the device 2112 (and/or outlet).

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

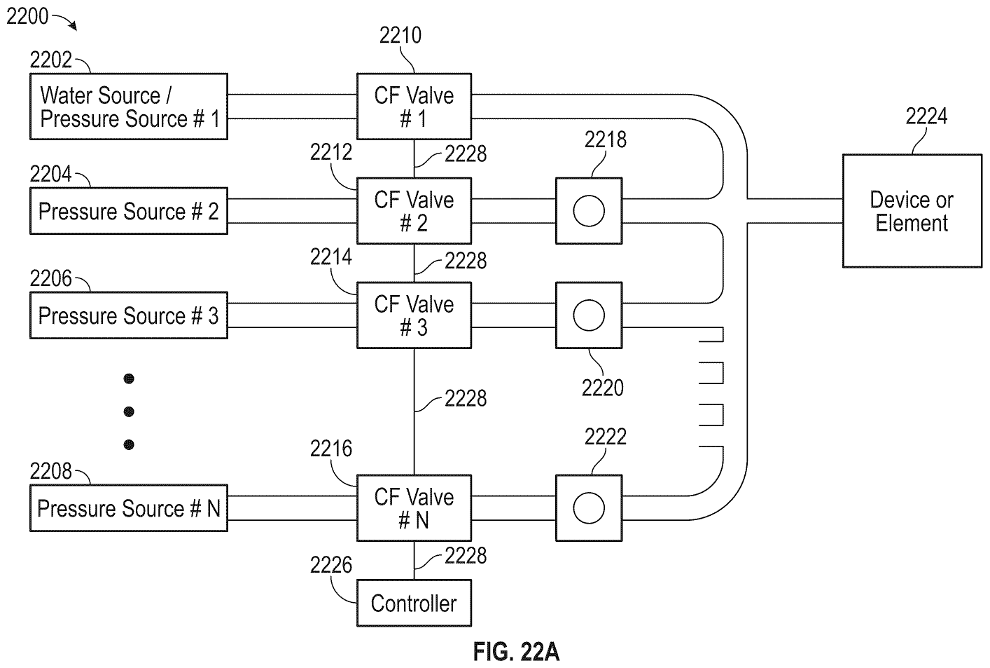

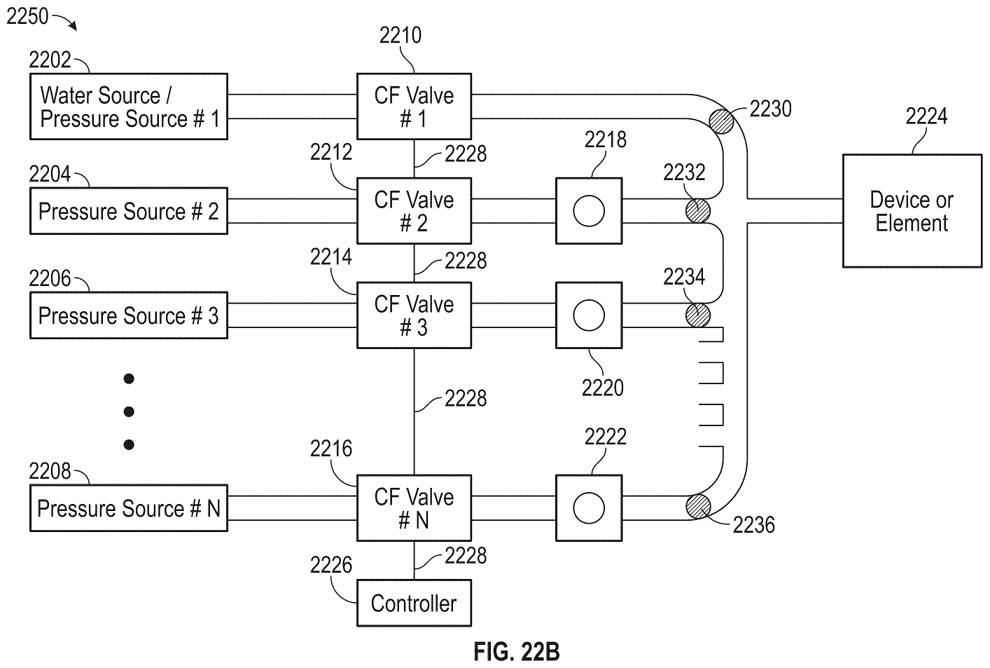

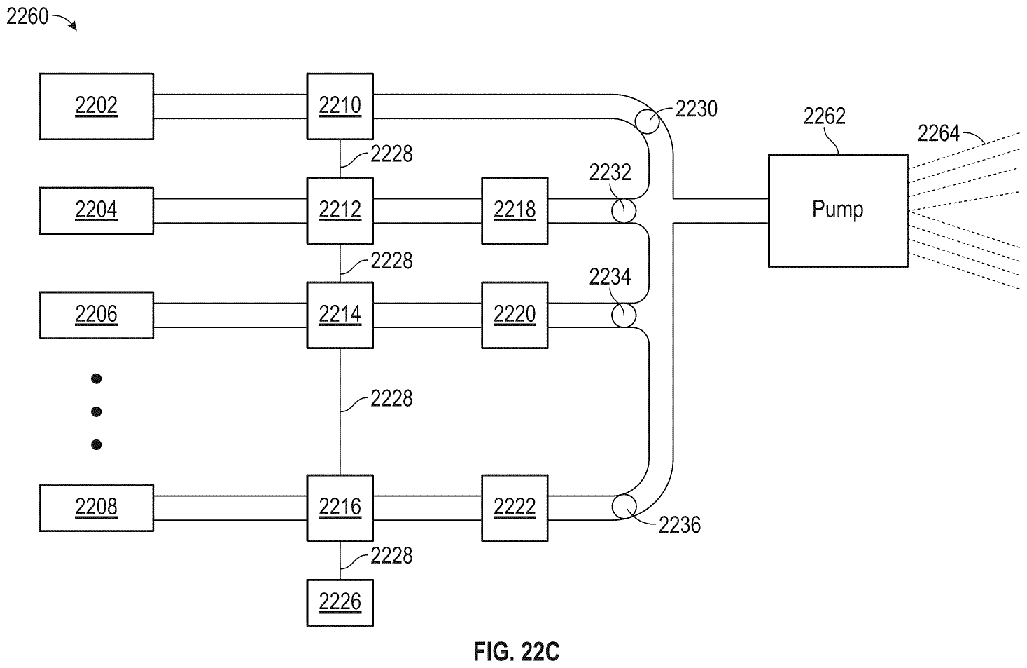

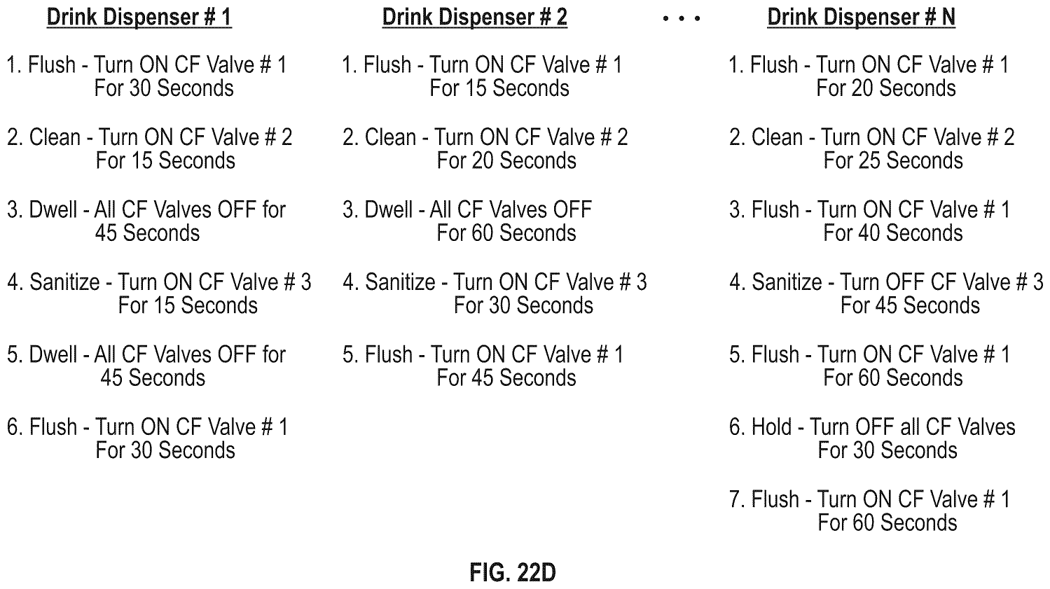

In FIG. 22A, a cleaning system 2200 includes a water source 2202 (and/or a first pressure source), a second pressure source 2204, a third pressure source 2206, an Nth pressure source 2208, a first CF Valve 2210, a second CF Valve 2212, a third CF Valve 2214, an Nth CF Valve 2216, a first container with a bag 2218, a second container with a bag 2220, an Nth container with a bag 2222, a device or element 2224, a controller 2226, and/or one or more control lines 2228. In one example, the first container with a bag 2218 has cleaning elements in the bag, the second container with a bag 2220 has sanitizer elements in the bag, and the Nth container with a bag 2220 has another element disclosed in this document.

In FIG. 22B, a cleaning system 2250 includes the water source 2202 (and/or the first pressure source), the second pressure source 2204, the third pressure source 2206, the Nth pressure source 2208, the first CF Valve 2210, the second CF Valve 2212, the third CF Valve 2214, the Nth CF Valve 2216, the first container with a bag 2218, the second container with a bag 2220, the Nth container with a bag 2222, the device or element 2224, the controller 2226, the one or more control lines 2228, a first check valve 2230, a second check valve 2232, a third check valve 2234, and/or an Nth check valve 2236. In one example, the first container with a bag 2218 has cleaning elements in the bag, the second container with a bag 2220 has sanitizer elements in the bag, and the Nth container with a bag 2220 has another element disclosed in this document.

In FIG. 22C, a cleaning system 2260 includes the water source 2202 (and/or the first pressure source), the second pressure source 2204, the third pressure source 2206, the Nth pressure source 2208, the first CF Valve 2210, the second CF Valve 2212, the third CF Valve 2214, the Nth CF Valve 2216, the first container with a bag 2218, the second container with a bag 2220, the Nth container with a bag 2222, the controller 2226, the one or more control lines 2228, the first check valve 2230, the second check valve 2232, the third check valve 2234, the Nth check valve 2236, a pump 2262, and/or one or more lines 2264 which lead to one or more devices and/or elements. In one example, the first container with a bag 2218 has cleaning elements in the bag, the second container with a bag 2220 has sanitizer elements in the bag, and the Nth container with a bag 2220 has another element disclosed in this document.

FIG. 22D shows one or more cleaning recipes and/or procedures. In various embodiments, variables may be changed. For example, the time period, concentration of a cleaning element, sanitizer element, and/or any other element in this document, the order of operation, and/or any other characteristic may be modified and/or changed based on the targeting element to be cleaned and/or sanitized.

One of the benefits of this cleaning and/or sanitizing system is that any cleaner, or sanitizer, or cleaner/sanitizer can be utilizing in one or more canisters and then any number of chemicals and/or any amount of water (dilution) in any recipe to match any cleaning need. The same type of equipment could need different recipes depending on how it is used. For example, coffee machine that runs very oily beans gets cleaned with a higher concentration and more dwell times and more cycles of the cleaner. In another example, a coffee machine that runs not-oily can use a lower concentration and fewer cycles. In another example, a coffee machine can be cleaned daily or every 2250 or cups. So, a low volume store does not overuse chemicals. In another example, a drink machine that mixes concentrates with carbonated water or still water can also have a customized recipe based on what is being dispensed. For example, if a horchata drink tends to build up yeast or a dairy drink is more susceptible to bacteria then those can be on a more frequent and/or on a cycle that is longer has more cleaning steps and stronger concentrate. The same cannister of XYZ cleaner or ABC Sanitizer of DEF Cleaner/Sanitizer can be used in any number of applications by customizing the recipe and the fluidics downstream.

In one embodiment shown in FIG. 22D, a first cleaning recipe is shown. The first cleaning recipe for drink dispenser number 1 may include: a first flush step (turn on CFValve #1 for 30 seconds); a first clean step (turn on CFValve #2 for 15 seconds); a first dwell step (turn on all CFValves off for 45 seconds); a first sanitize step (turn on CFValve #3 for 15 seconds); a second dwell step (turn all CFValves off for 45 seconds); and/or a second flush step (turn on CFValve #1 for 30 seconds).

In another embodiment shown in FIG. 22D, a second cleaning recipe is shown. The second cleaning recipe for drink dispenser number 2 may include: a first flush step (turn on CFValve #1 for 15 seconds); a first clean step (turn on CFValve #2 for 20 seconds); a first dwell step (turn on all CFValves off for 60 seconds); a first sanitize step (turn on CFValve #3 for 30 seconds); and/or a second flush step (turn on CFValve #1 for 45 seconds).

In an nth embodiment shown in FIG. 22D, an nth cleaning recipe is shown. The nth cleaning recipe for drink dispenser number N may include: a first flush step (turn on CFValve #1 for 20 seconds); a first clean step (turn on CFValve #2 for 25 seconds); a second flush step (turn on CFValve #1 for 40 seconds); a first sanitize step (turn on CFValve #3 for 45 seconds); a third flush step (turn on CFValve #1 for 60 seconds); a first hold step (turn off all CFValves for 30 seconds); and/or a fourth flush step (turn on CFValve #1 for 60 seconds).

In another embodiment shown in FIG. 22D, a cleaning recipe is shown. The cleaning recipe for drink dispenser may include: a first flush step (turn on CFValve #1 for 40 seconds); a first clean/sanitize step (turn on CFValve #2 for 35 seconds); a first dwell step (turn all CFValves off for 60 seconds); and/or a second flush step (turn on CFValve #1 for 90 seconds).

In another embodiment shown in FIG. 22D, a cleaning recipe is shown. The cleaning recipe for drink dispenser may include: a first flush step (turn on CFValve #1 for 50 seconds); a first/sanitize step (turn on CFValve #2 for 30 seconds); a first dwell step (turn all CFValves off for 120 seconds); and/or a second flush step (turn on CFValve #1 for 120 seconds).

In another embodiment shown in FIG. 22D, a cleaning recipe is shown. The cleaning recipe for drink dispenser may include: a first flush step (turn on CFValve #1 for 40 seconds); a first clean/sanitize step (turn on CFValve #2 for 35 seconds); and/or a first dwell step (turn all CFValves off for 60 seconds.

In another embodiment shown in FIG. 22D, a cleaning recipe is shown. The cleaning recipe for drink dispenser may include: a first clean step (turn on CFValve #2 for 50 seconds); a first dwell step (turn all CFValves off for 90 seconds); and/or a first flush step (turn on CFValve #1 for 30 seconds).

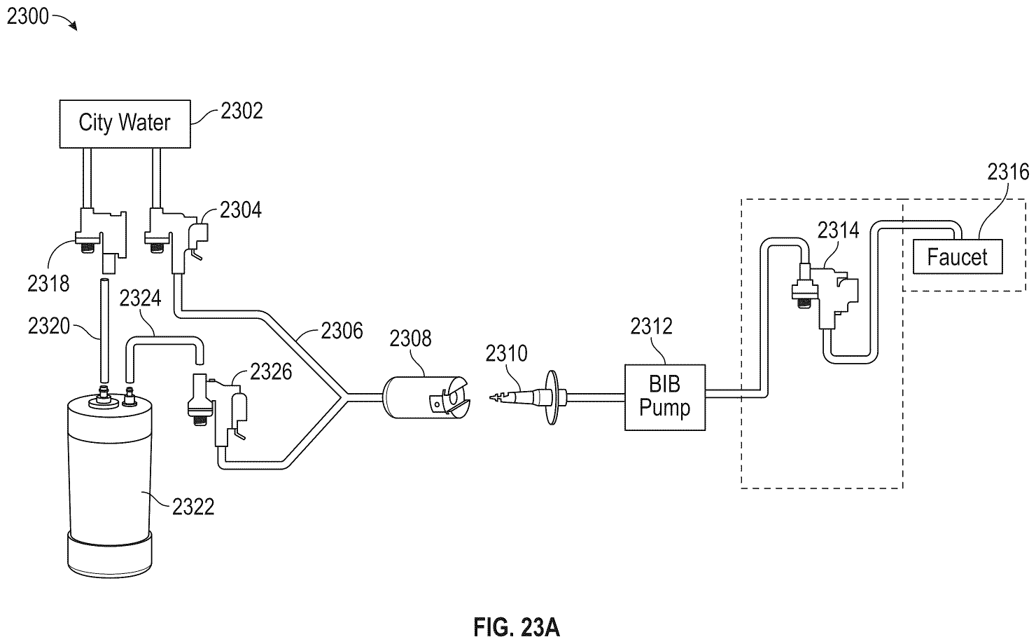

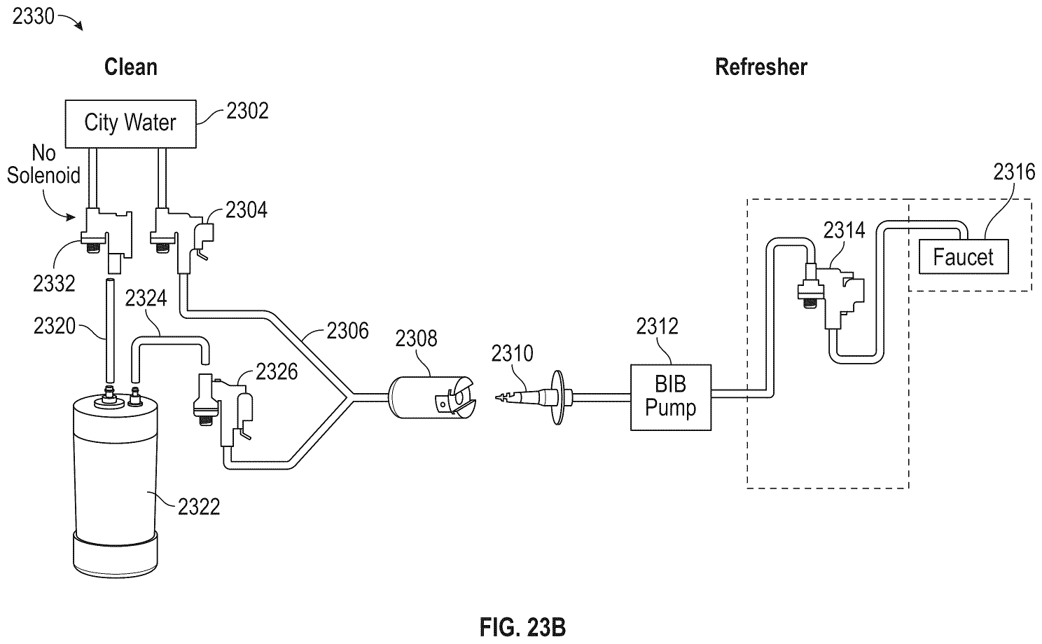

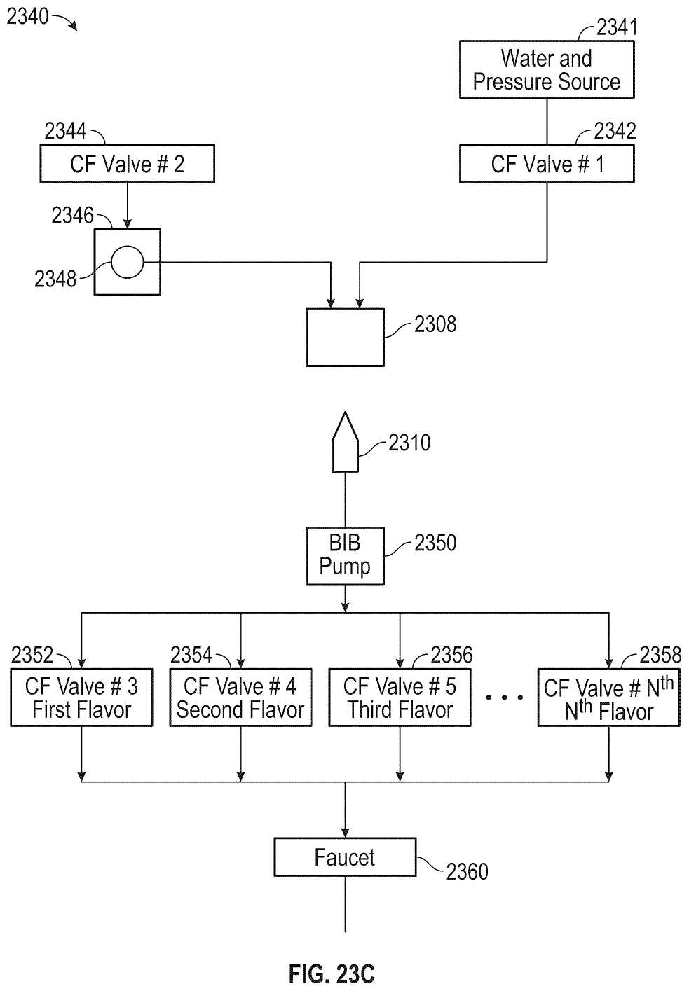

FIG. 23A shows a system 2300 including a water source 2302, an incoming water CF Valve 2304 (e.g., electric), a water line 2306, an adapter 2308, a fitting 2310, a bag-in-bottle device 2312, an outlet CF Valve 2314, a faucet 2316, a second incoming water CF Valve (e.g., electric) 2318, an inlet cleaning line 2320, a cleaning container 2322, an outlet cleaning line 2324, and/or an outlet cleaning line CF Valve 2326.

FIG. 23B shows a system 2330 including the water source 2302, the incoming water CF Valve 2304 (e.g., electric), the water line 2306, the adapter 2308, the fitting 2310, the bag-in-bottle device 2312, the outlet CF Valve 2314, the faucet 2316, a second incoming water CF Valve (e.g., non-electric) 2332, the inlet cleaning line 2320, the cleaning container 2332, the outlet cleaning line 2324, and/or the outlet cleaning line CF Valve 2326.

FIG. 23C shows a system 2340 including a water/pressure source 2341, a first CF Valve 2342, a second CF Valve 2344, a container 2346, a bag 2348 (with cleaning solution, sanitizer solution, or both), the adapter 2308, the fitting 2310, a bag-in-bottle device 2350, a third CF Valve 2352 (e.g., first flavor), a fourth CF Valve 2354 (e.g., second flavor), a fifth CF Valve 2356 (e.g., third flavor), an Nth CF Valve 2358 (e.g., Nth flavor), and/or a faucet 2360.

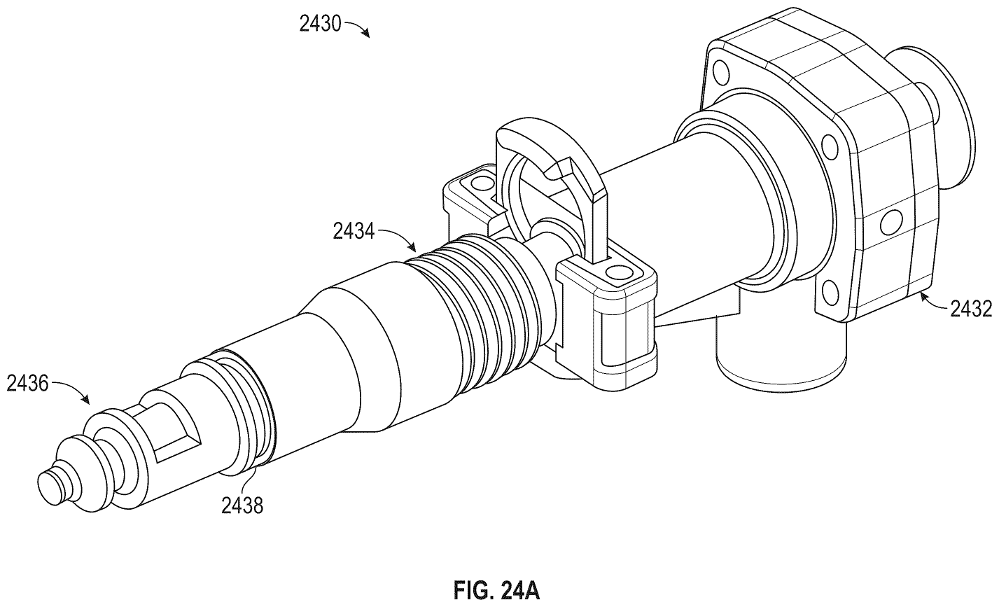

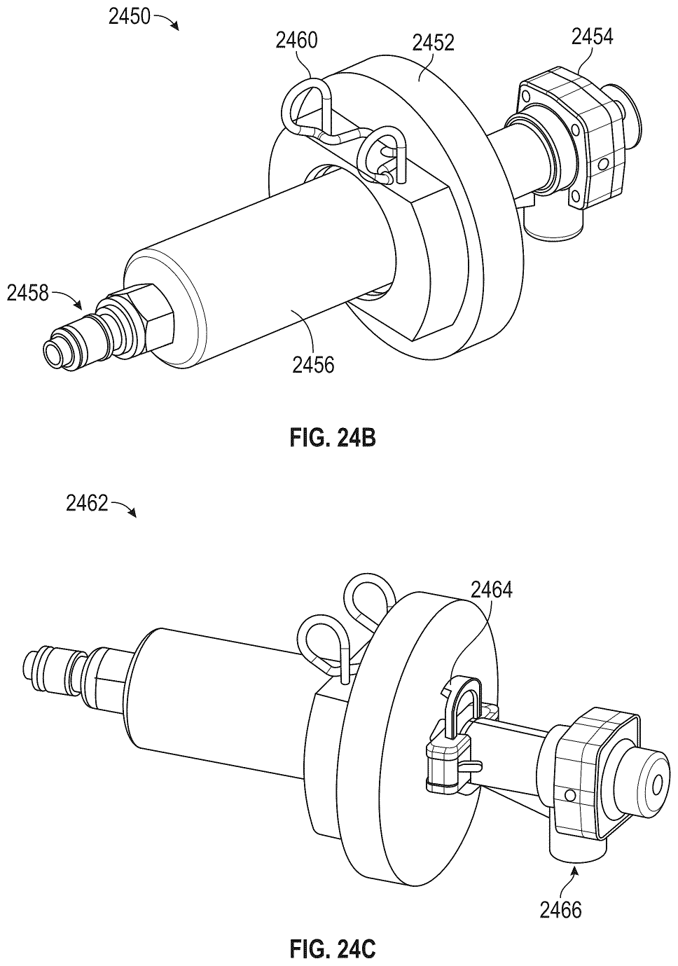

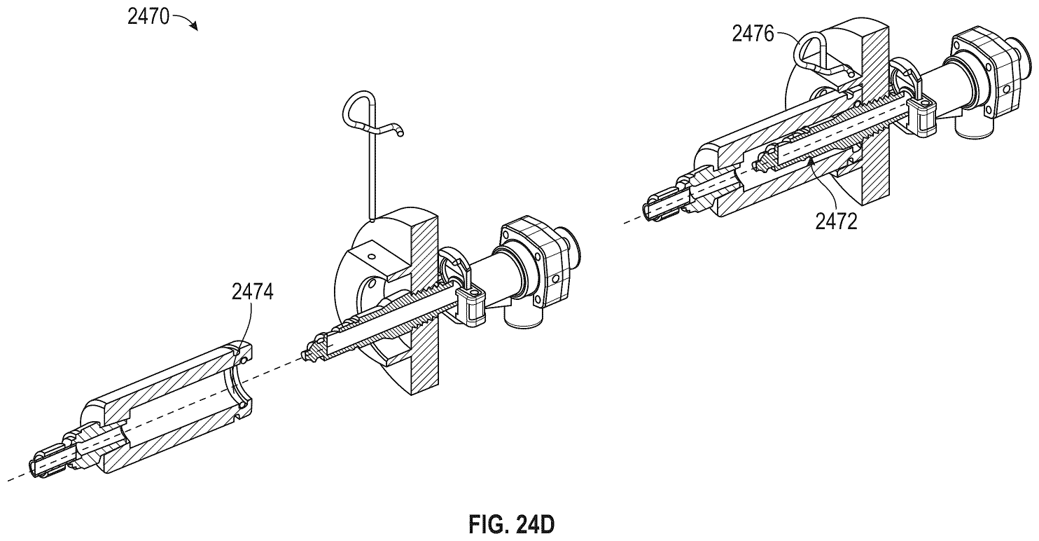

In FIGS. 24A-24D, illustrations of a fitting being utilized to connect the bag to the faucet are shown, according to various embodiments. In FIG. 24A, a fitting 2430 includes an external end 2432, a thread 2434, an inside end 2436, and/or an O-ring 2438. In one example, the fitting 2430 is a connection device between the ingredients bag 2414 and the dispensing area 2418. In this example, the fitting 2430 connects with the ingredients bag 2414 via the inside end 2436 entering the ingredients bag 2414. In addition, the fitting 2430 connects with the dispensing area 2418 via the external end 2432.

In FIG. 24B, a fitting 2450 includes a lid 2452, a faucet 2454, a cleaning fixture/sleeve 2456, a dry break 2458, and/or a retaining clip 2460. In this example, the CFive on the faucet side and/or dispensing side may connect to the bag inside the pressurized vessel with a connection fitting 2450. In this example, the fitting 2450 connects the bag to dispensing area through the lid. In another example, the canister and/or lid can have an additional feature that holds the cap in the bag in place to make insertion of the connection directly into the bag consistent (e.g., no side loading).

In FIG. 24C, a fitting 2462 includes a clip 2464 and a faucet outlet 2466. In this example, the cleaning fixture can be connected to the inside of the lid for a clean-in-place functionality. In addition, the fitting 2462 will allow for cleaning and/or sanitizing fluid to clean the outside and inside of the fitting and to pass through the fitting and out the CF Valve by the faucet to clean all wetted surfaces. In FIG. 24D, a fitting 2470 includes various internal elements 2472, an O-ring 2474, and/or a retaining clip 2476. In one example, cleaning/sanitizing fluid cleans outside of probe fitting pas Cap/Bag O-ring seal (e.g., wetted surfaces). In another example, the O-ring in the sleeve seals to bottom of probe. In another example, the retaining clip keeps sleeve/fixture in place when pressurized.

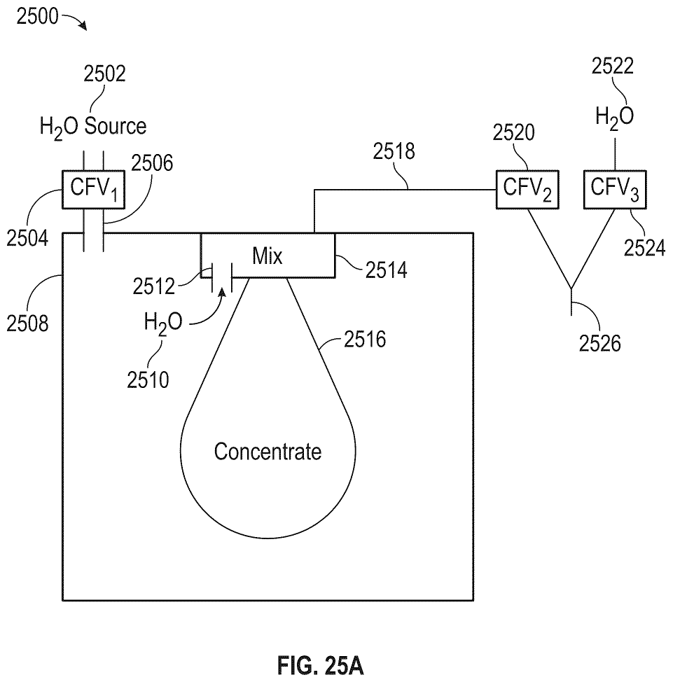

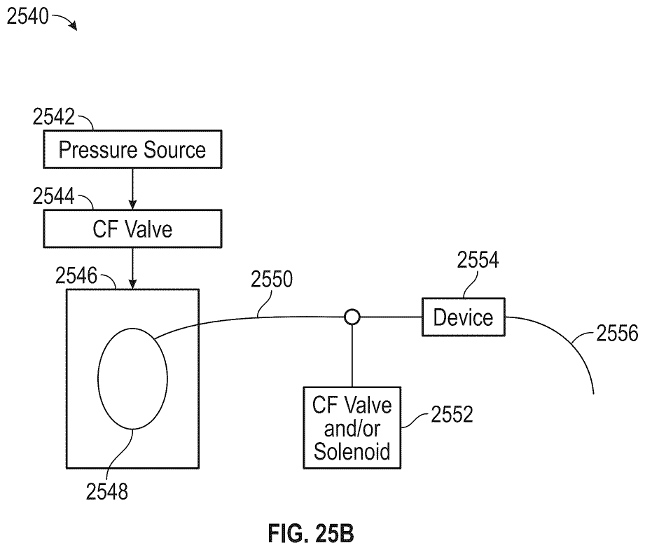

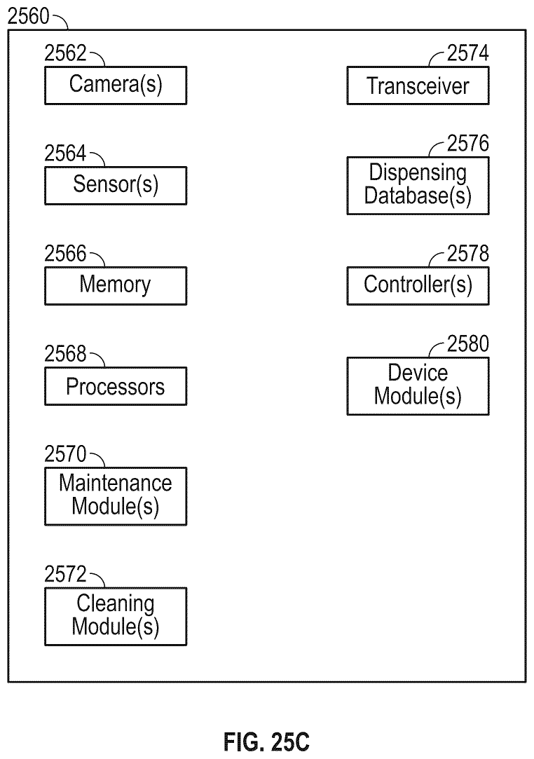

FIG. 25A shows a cleaning system 2500 which includes a first H₂O source 2502, a first CF Valve 2504, a cleaning solution input area 2506, a cleaning device 2508, an inlet 2510 to a mixing area 2514, which allows water to enter the mixing area 2514, a cleaning concentrate bag 2516 where a non-diluted, pre-diluted, and/or full diluted cleaning concentrate enters the mixing area 2514 to mix with the water from inlet 2510, the non-diluted, pre-diluted, and/or full diluted cleaning concentrate leaves the cleaning device 2508 via an exit line 2518 to a second CF Valve, which obtains a final mixture ratio by being mixed with the second water source 2522 and a third CF Valve 2524 to obtain cleaning solution output 2526.

In various examples shown in FIG. 22D, chemical compatibility, system material tolerances, Ph levels, drink materials, ratio requirements, and/or any other condition disclosed in this document, may be utilized to determine whether to non-dilute, pre-dilute, and/or fully dilute a cleaning system. For example, a 100 to 1 ratio; a 400 to 1 ratio; a 800 to 1 ratio; and/or a 1000 to 1 ratio may be utilized. In one example for coffee, a 100 to 1 ratio for the cleaning solution may be utilized.

FIG. 25B shows a cleaning system 2540, which includes a pressure source 2542, a first CF Valve 2544, a container 2546, a bag 2548, a bag outlet line 2550, a second CF Valve and/or a first solenoid 2552, a device 2554, and a device outlet line 2556. In this example, the CF Valves 2544 and 2552 may be non-electric CF Valves and/or electric CF Valves.

FIG. 25C shows a block diagram 2560 which includes a camera(s) 2562, sensor(s) 2564, memory 2566, processor(s) 2568, a maintenance module(s) 2570, cleaning module(s) 2572, a transceiver 2574, a dispensing database(s) 2576, controller(s) 2578, and/or device module(s) 2580.

In one example, a maintenance module 2570 for a first dispensing system may include every drinking dispensing data (e.g., number of drinks, ratio, last maintenance cycle, temperature data, time of use data, etc.) for one or more dispensing devices.

In another example, a cleaning module 2572 may include different cleaning recipes for a dispensing device based on the dispensing device usage since the last cleaning cycle. For example, a large amount of high viscosity drinks since the last cleaning cycle may indicate that a higher concentrate cleaning solution, recipe, and/or procedure should be utilized. This information may be included for a plurality of dispensing devices in the dispensing database 2576. Further, the controller 2578 may control one or more devices (CFValves, solenoids, check valves, etc.) to implement one or more cleaning recipes.

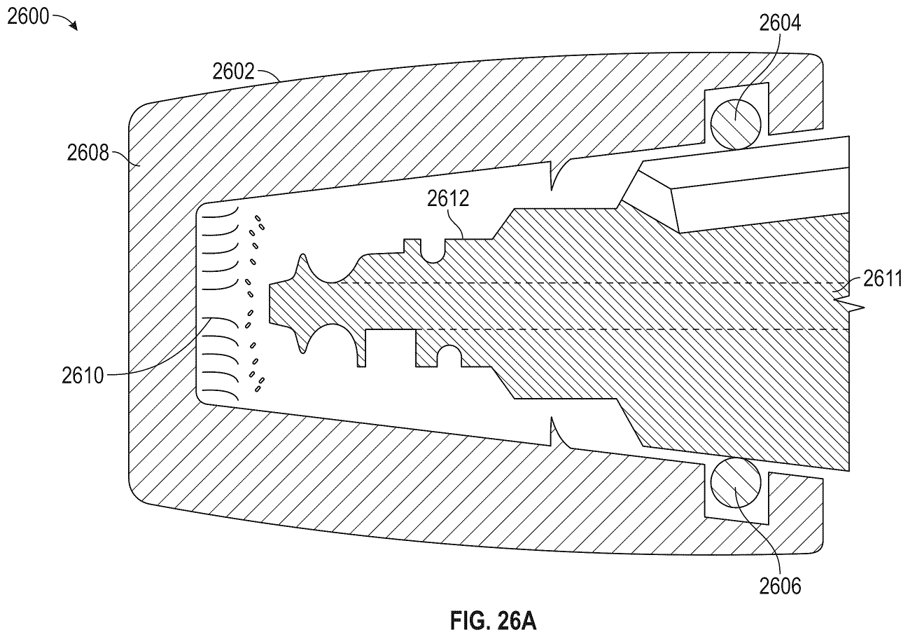

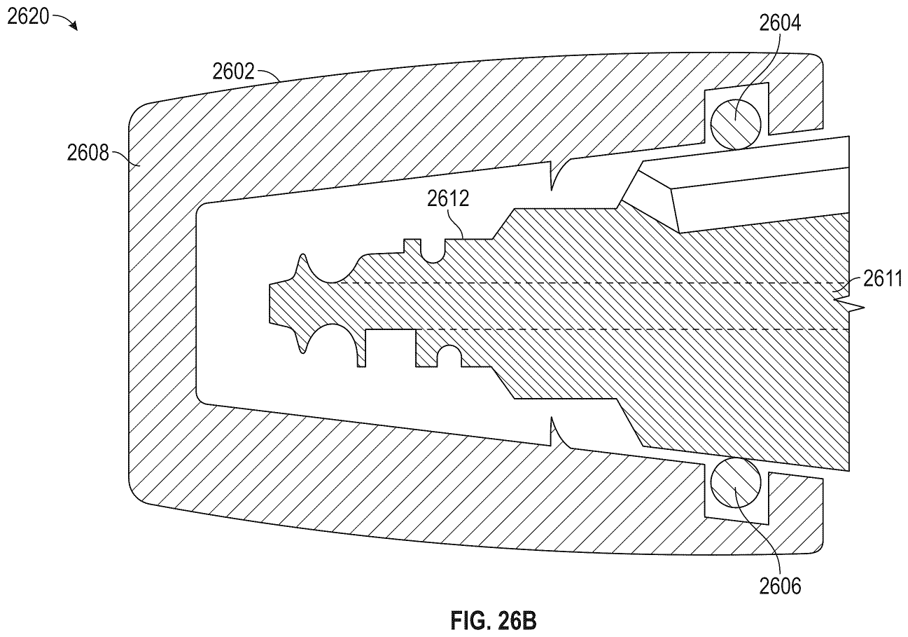

FIG. 26A shows the fitting device 2611 and the adapter 2602 connected for the cleaning and/or sanitizing operation. In this example, the adapter 2602 has an inlet area 2604, an outlet area 2606, one or more walls 2608, and a cleaning element area 2610. In this example, water enters via the inlet area 2604 and combines with the cleaning element area 2610 to create a cleaning solution (and/or sanitizer solution). In this example, the adapter 2602 may contain enough cleaning elements in cleaning element area 2610 for a single use, two uses, three uses, etc. However, in a preferred embodiment, the adapter 2602 is a single use device. In addition, one or more fitting areas 2612 would not be cleaned during a cleaning operation that did not include the adapter 2602.

FIG. 26B shows the fitting device 2611 and the adapter 2602 connected from the cleaning and/or sanitizing operation. In this example, there is no cleaning element area 2610. Therefore, the cleaning and/or sanitizer would enter the inlet area 2604 to clean and/or sanitize the fitting device 2611 and/or the one or more fitting areas 2612.

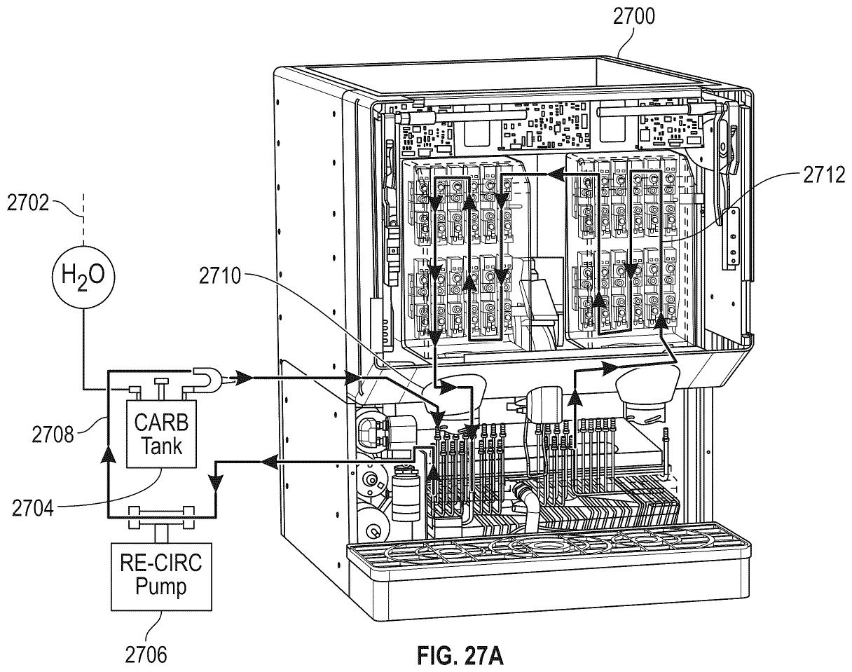

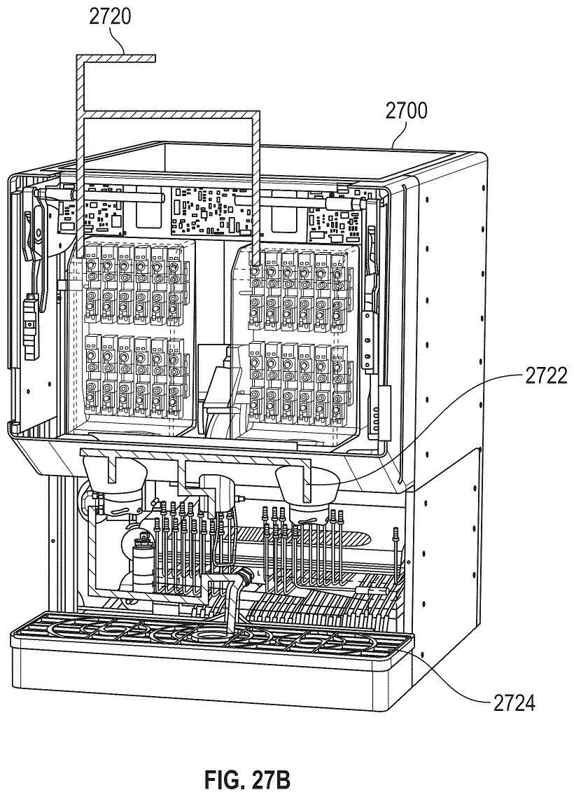

In FIG. 27A, an illustration of a dispensing device 2700 is shown. In one example, the dispensing device 2700 may be coupled to an H₂O source 2702 (and/or any other liquid source (e.g., carbonated water, etc.), a tank 2704 (e.g., carbonated tank, nitrogen tank, etc.), a recirculation pump 2706, and/or one or more lines 2708. Further, the dispensing device 2700 may include one or more dispensing areas 2710 and/or one or more cooling lines 2712.

In FIG. 27B, another illustration of a dispensing device 2700 is shown, according to various embodiments. In this example, dispensing device 2700 may include one or more input lines 2720, one or more dispensing areas 2722, and/or an ice tray 2724.

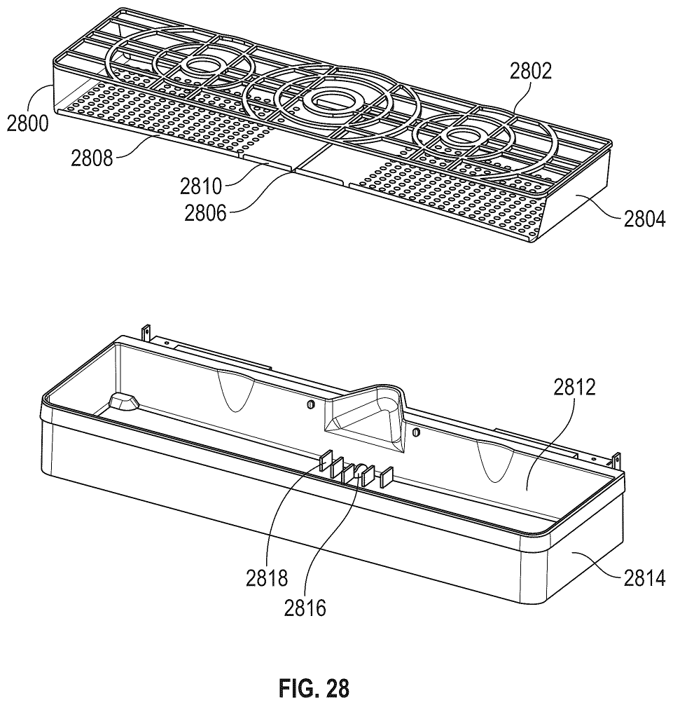

In FIG. 28, an illustration of an ice rack 2800 is shown, according to one embodiment. In one example, ice rack 2800 may include a metal ice rack 2802 (and/or a plastic and/or glass and/or wood and/or any other material), a filter 2804 (e.g., made of metal, plastic, wood, etc.), a center line 2806, a left side of a bottom 2808 (and a right side of the bottom), a left center section 2810, a bucket base 2812 (e.g., metal, plastic, wood, etc.), a wrap base 2814 (e.g., metal, plastic, wood, etc.), a drain out area 2816, and/or one or more fins 2818. In one example, the metal ice rack 2802 has three circular patterns where a first circular pattern is under a first dispensing area; a second circular pattern is under an ice dispensing area; and a third circular pattern is under a second dispensing area.

In another example, the filter 2804 has three circular patterns where a first circular pattern is under a first dispensing area; a second circular pattern is under an ice dispensing area; and a third circular pattern is under a second dispensing area. In addition, the center line 2806 is in the middle of the ice rack 2800 and may be positioned at the center of the ice dispensing area. In another example, the left side of the bottom 2808 and a right side of the bottom may have a plurality of holes for drainage. In addition, the bottom of the ice rack 2800 which includes the left side of the bottom 2808 and a right side of the bottom may be angled downwardly from the center line 2806 in both directions (e.g., left and right). This angle may be 1 degree, 2 degrees, 3, degrees, 4, degrees, 5 degrees, 6 degree, 7 degrees, 8, degrees, 9, degrees, 10 degrees, 11 degrees, 12 degrees, 13, degrees, 14, degrees, 15 degrees, 16 degrees, 17 degrees, 18, degrees, 19, degrees, and/or 20 degrees, according to various embodiments. In another example, the left center section 2810 and/or the right center section may not have any holes (and/or is a solid piece of material). Further, the left center section 2810 and/or the right center section may be positioned over the drain out area 2816, and/or one or more fins 2818. Based on the left center section 2810 and/or the right center section not having a holes and/or drainage areas, the drain out area 2816, and/or one or more fins 2818 are less likely to become clogged because ice, water, waste, and/or any other material cannot fail on top of the drain out area 2816, and/or one or more fins 2818. In another example, the one or more fins 2818 stops debris from clogging up the drain out area 2816.

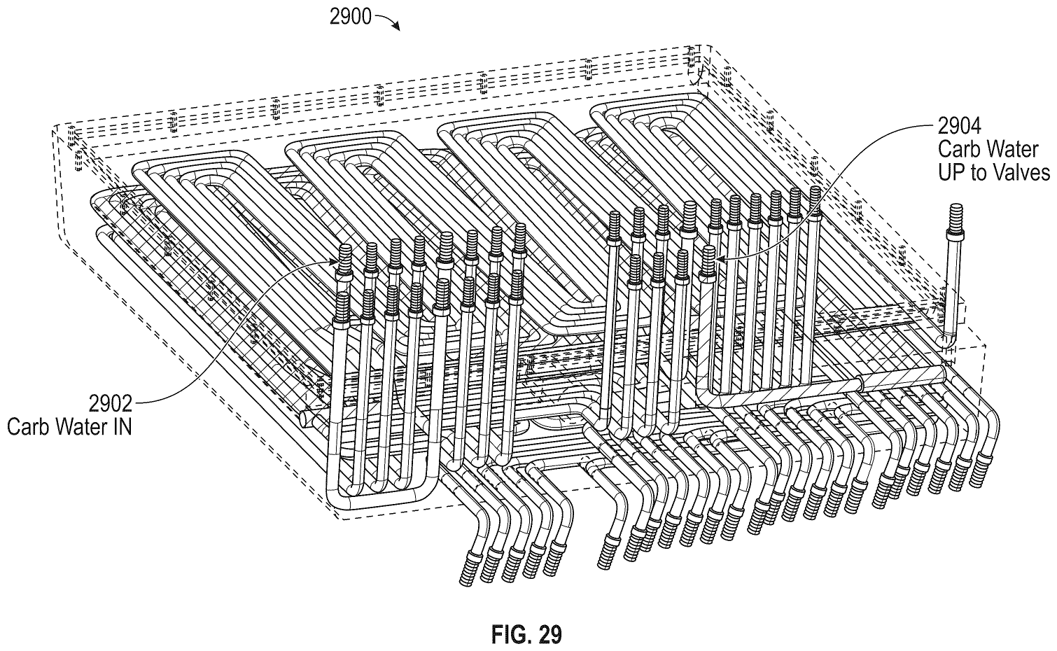

In FIG. 29, an illustration of a cooling system 2900 is shown, according to one embodiment. In one example, the cooling system 2900 may include a carbonated water input line 2902 which goes through various heat exchangers to cool down the carbonated water. In this example, the carbonated water exits the various heat exchangers at a carbonated water exit area 2904.

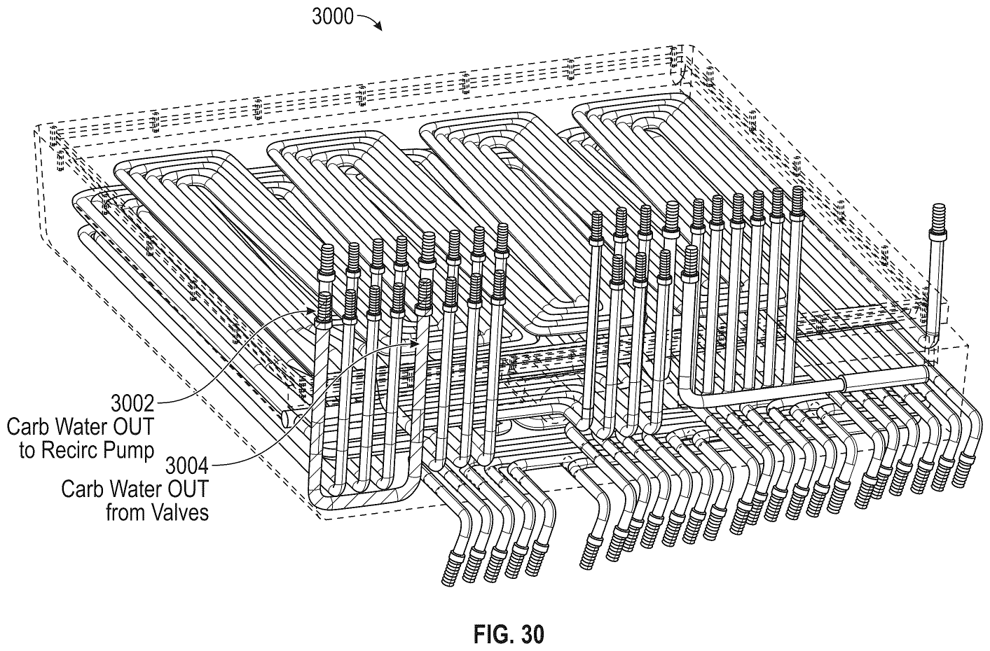

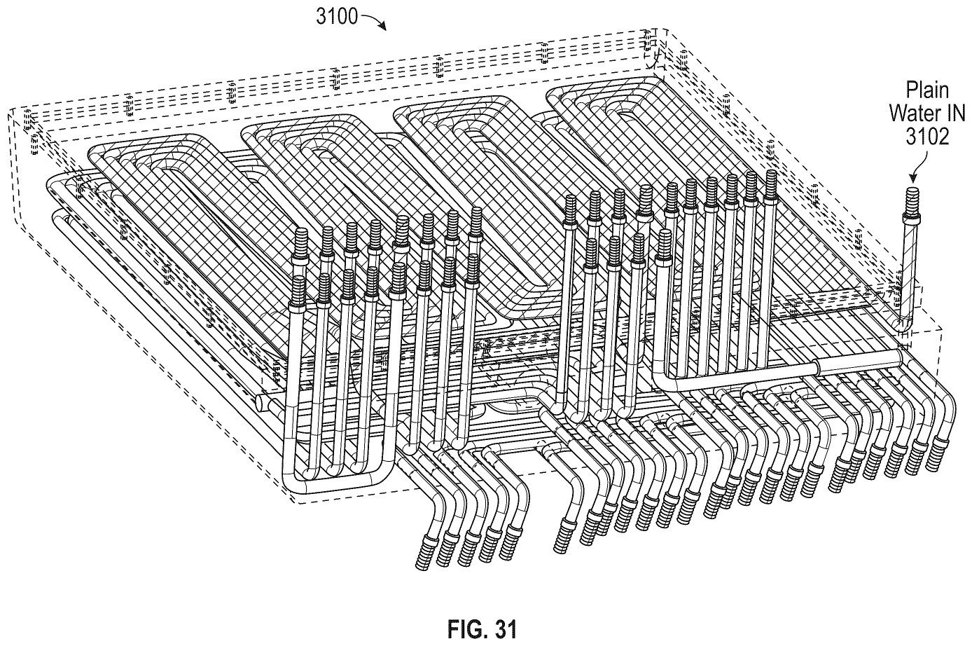

In FIG. 30, another illustration of a cooling system 3000 is shown, according to one embodiment. In one example, the cooling system 3000 may include a first carbonated water out area 3002 which goes to a recirculation pump. In addition, the cooling system 3000 may include a second carbonated water out area 3004 which goes to one or more valves. In another example, a cooling system 3100 shown in FIG. 31 may include a plain water input area 3102.

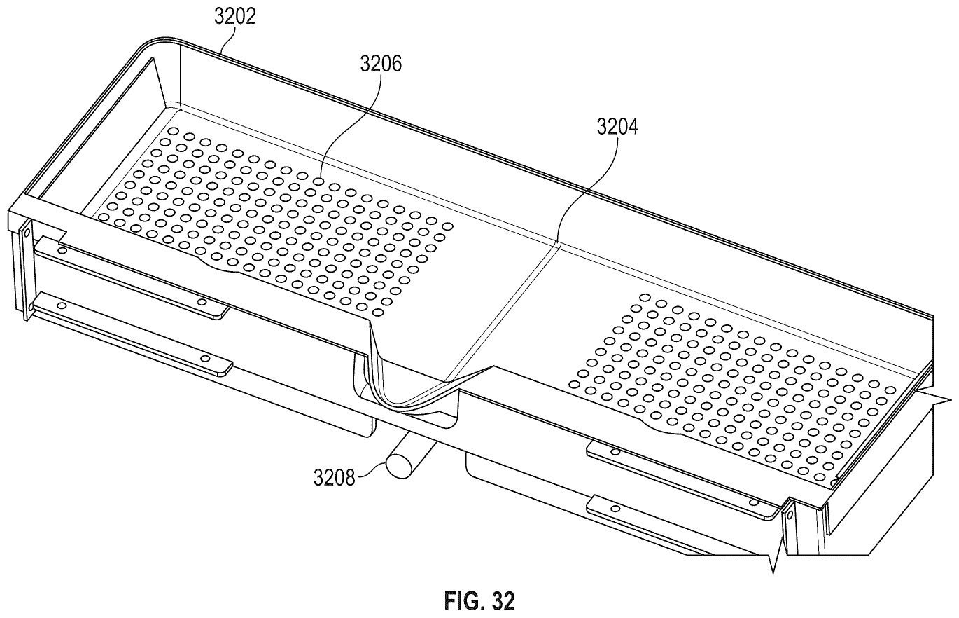

In FIG. 32, an illustration of an ice rack 3202 is shown, according to one embodiment. In this example, the ice rack 3202 may include a plurality of holes 3206 (and/or drainage areas) on a right side and a left side of a filter bottom. In addition, a left side and a right side of a center line 3204 may have no holes and/or drainage areas to protect a drainage line 3208. In one example, the left side and the right side of the center line 3204 protects the drainage line 3208 and/or one more fins 2818 (see FIG. 28) because the left side and right side of the center line 3204 do not allow ice, water, and debris to built up at the drainage line 3208.

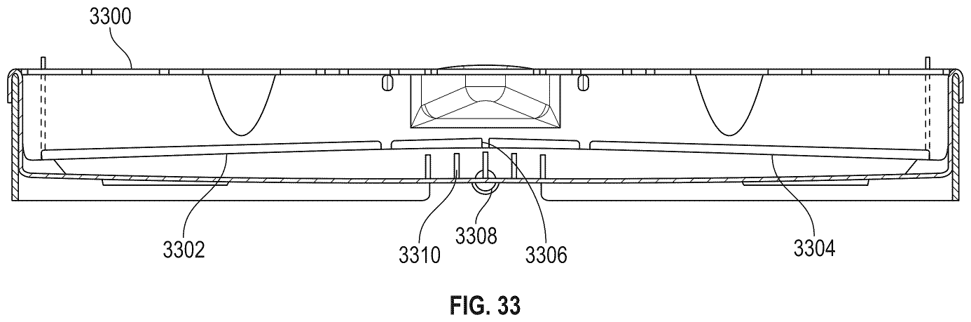

In FIG. 33, another illustration of an ice rack 3300 is shown, according to one embodiment. In one example, ice rack 3300 may include a left side 3302 of a filter, a right side 3304 of the filter, and a center line 3306 located between the left side 3302 and the right side 3304. In another example, the left side 3302 of the filter and the right side 3304 of the filter may have a plurality of holes (See FIG. 32) for drainage. In addition, the left side 3302 of the filter and the right side 3304 of the filter may be angled downwardly from the center line 3306 in both directions (e.g., left and right). This angle may be 1 degree, 2 degrees, 3, degrees, 4, degrees, 5 degrees, 6 degree, 7 degrees, 8, degrees, 9, degrees, 10 degrees, 11 degrees, 12 degrees, 13, degrees, 14, degrees, 15 degrees, 16 degrees, 17 degrees, 18, degrees, 19, degrees, and/or 20 degrees, according to various embodiments. In another example, the left center section 2810 and/or the right center section may not have any holes (and/or is a solid piece of material) (See FIG. 28). Further, the left center section 2810 and/or the right center section may be positioned over the drain out area 2816, and/or one or more fins 2818. Based on the left center section 2810 and/or the right center section not having a holes and/or drainage areas, the drain out area 2816, and/or one or more fins 2818 are less likely to become clogged because ice, water, waste, and/or any other material cannot fail on top of the drain out area 2816, and/or one or more fins 2818. In another example, the one or more fins 2818 stop debris from clogging up the drain out area 2816 (See FIG. 28). In another example, the ice rack 3300 may include one or more drainage lines 3308 and/or one or more fins 3310.

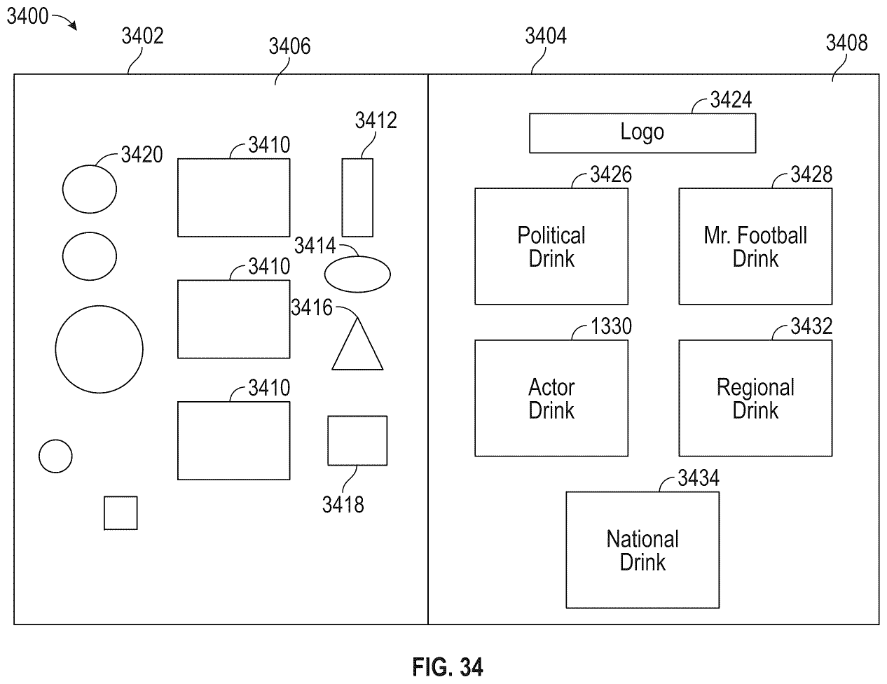

In FIG. 34, an illustration of a user interface 3400 for a dispensing system is shown, according to one embodiment. In one example, the user interface 3400 may include a first display 3402 with a first display area 3406 and a second display 3404 with a second display area 3408. In one example, the first display 3402 and the second display 3404 are on one display device. In another example, the first display 3402 and the second display 3404 are on two or more display devices. In one example, the first display area 3406 may include a first type of icon 3410, a second type of icon 3412, a third type of icon 3414, a fourth type of icon 3416, a fifth type of icon 3418, and an Nth type of icon 3420. In various embodiments, each different type of icon may indicate a different matter. For example, the first type of icon 3410 may indicate and/or be associated with the drinks with the most sales volume (e.g., the top 5, , , , the top 10, etc.). In another example, the second type of icon 3412 may indicate and/or be associated with a specialty drink (e.g., limited time offer-the purple dream). Further, the third type of icon 3414 may indicate and/or be associated with non-sugar drinks. In addition, the fourth type of icon 3416 may indicate and/or be associated with flavor shots (e.g., cherry, lime, etc.). In another example, the fifth type of icon 3418 may indicate and/or be associated with an energy booster (e.g., caffeine, protein, vitamins, etc.). In another example, the sixth type of icon 3420 may indicate and/or be associated with drinks with average and/or low sales volumes.

In another example, the second display area 3408 may include a logo icon 3424, a political drink icon 3426, a sports team drink icon 3428, an actor and/or celebrity drink icon 1330, a regional drink icon 3432, and/or a national drink icon 3434. In one example, the logo icon 3424 can be utilized to highlight one or more company brands. In another example, the political drink icon 3426 can be utilized to highlight one or more political parties and/or personal and/or themes and/or messages. For example, if you support proposition X, then drink Y. If you don't support proposition X, then drink Z. In another example, the sports team drink icon 3428 can be utilized to highlight one or more teams, one or more players, one or more mascots, etc. For example, if you think Team Y is going to win the big game, then drink A. If you think Team Z is going to win the big game, then drink B. In another example, the actor and/or celebrity drink icon 1330 may be utilized to highlight one or more actors and/or one or more celebrities. For example, if you like Bob Doe, in once upon a field (or just in general), then drink C. In another example, the regional drink icon 3432 may be used to highlight a local drink preference. For example, City X drinks ZZ almost 80 percent of the time. You should drink ZZ too. In another example, the a national drink icon 3434 may be used to highlight a national drink preference. For example, 65 percent of American drink GG, you should drink GG too.

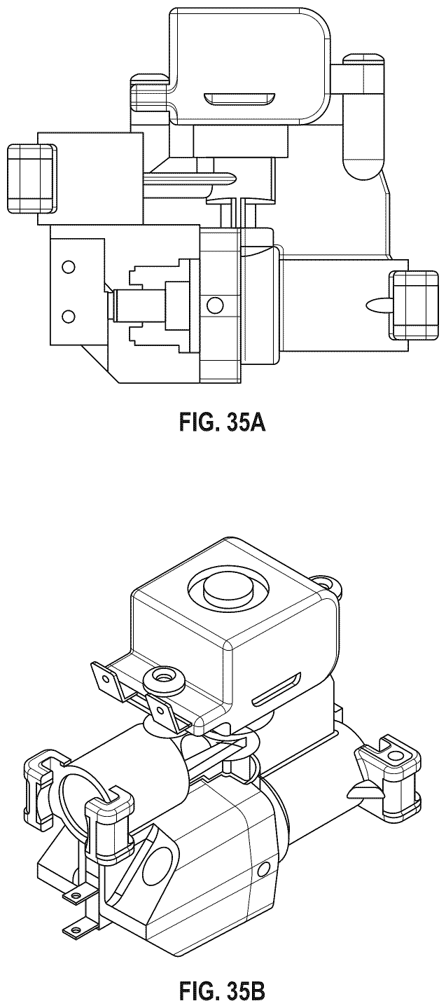

In FIGS. 35A-35B, illustrations of a CFiVe Switch cap are shown, according to various embodiments. In one example, the CFiVe switch cap can be used to determine the presence of pressure, and thus product that is at the inlet of the CFiVe flow control valve. This is accomplished by using a microswitch which is actuated with a plunger by the movement of the retainer assembly. In one example, the switch is retained in the cap. Further, the switch cap can be used in addition to or in place of a pressure switch as a sold out feature and/or as a means of detecting actuation downstream of an open valve.

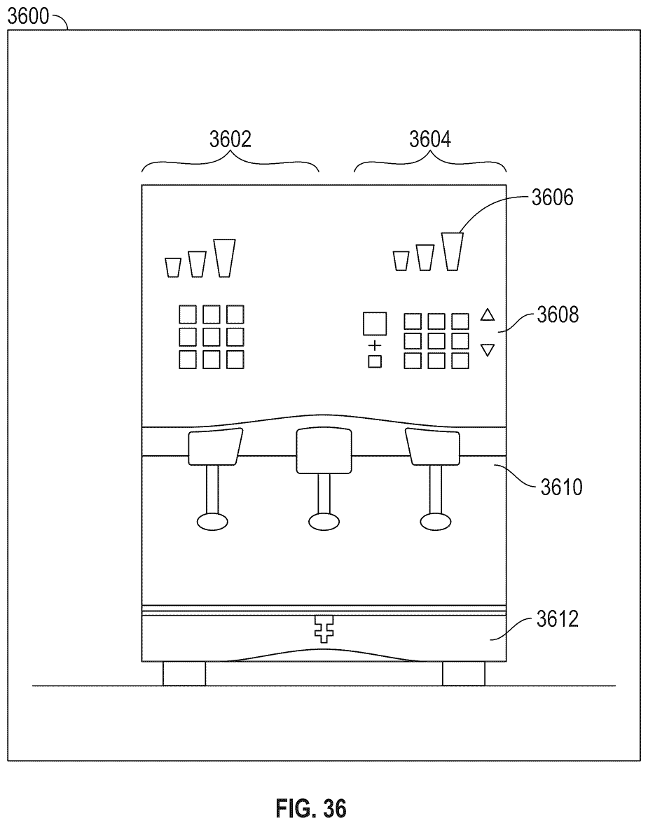

In FIG. 36, an illustration of a dispensing system 3600 is shown, according to one embodiment. In one example, the dispensing system 3600 may include a first drink selection area 3602 (e.g., high % Core) and a second drink selection area (e.g., low % recipe). In addition, a drink size area 3606 may be include in the dispensing system 3600. In another example, one or more functional buttons 3608 may be utilized for a scrolling function, one or more flavor shots, one or more energy shots, one or more additives, and/or any combination thereof. In another example, the dispensing system 3600 may include one or more drink dispensing areas and/or ice dispensing areas 3610. Further, an ice rack 3612 may be utilized as previously described in this disclosure.

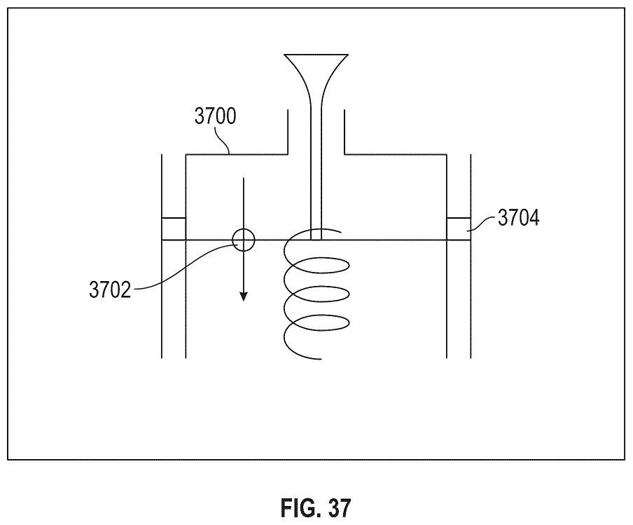

In FIG. 37, an illustration of a ventless valve 3700 is shown, according to one embodiment. In one example, ventless valve 3700 may include one or more holes 3702 and one or more closed areas 3704. In one example, the use of a ventless valve (e.g., a ventless CF Valve) has advantages when a chemical mixing and/or beverage dispensing function is utilized. For example, if there is a diaphragm failure there is no leak from the valve. In this example, any discharge would be downstream through the plumbing into the drain. Further in the case of a solenoid-controlled system, no leak because the solenoid would stay closed and not allow any flow. Further, this ventless valve may produce a sold-out closed valve situation. In one example, as the fluid (liquid and/or gas) leaks through the diaphragm into the closed spring cup/cap the fluid pressure will equalize on either side of the diaphragm and the fluid on the cap side of the diaphragm will act with the spring to hold the diaphragm in the sealing ring in a closed position. This eliminates any flow through the valve. This will eliminate issues with a tear and/or puncture in the diaphragm which is the most common source of failure.

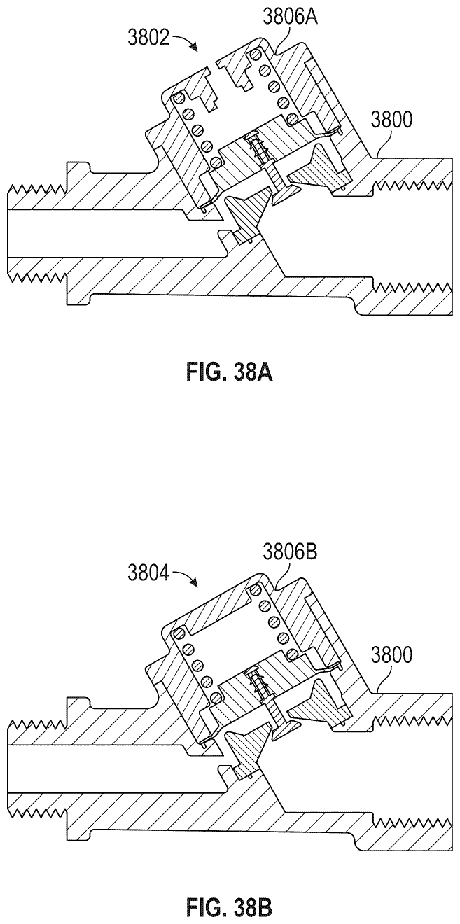

FIGS. 38A-38B show illustrations of a ventless CF Valve, according to various embodiments. In an example, a valve 3806A is coupled to a flow path 3800. In this example, a vent 3802 is utilized in the valve 3806A. In an embodiment shown in FIG. 38B, a valve 3806B is coupled to the flow path 3800; however, valve 3806B does not have a vent 3804 which provide all the benefits noted above for a ventless valve.

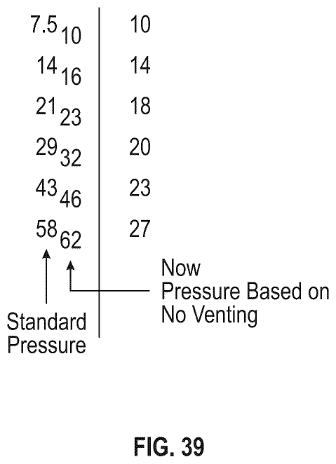

In FIG. 39, an illustration of pressures which can be utilized with the ventless CF Valve is shown; according to various embodiments. In various examples, one or more standard pressures can be achieved with a vented valve. The standard pressures include 7.5, 14, 21, 29, 43, and 58. However, the ventless valve can achieve other pressures, which include 10, 16, 23, 32, 46, and 62. In various other examples, the new pressures may be 10, 14, 18, 20, 23, and/or 27. The pressures are in PSI.

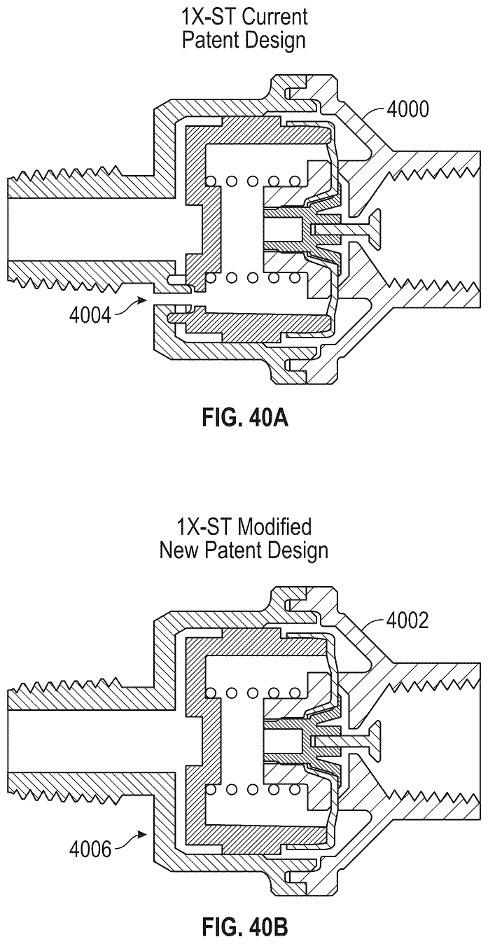

FIGS. 40A-40B show illustrations of a ventless CF Valve, according to various embodiments. In an example, a valve 4000 is coupled to a flow path. In this example, a vent 4004 is utilized in the valve 4000. In an embodiment shown in FIG. 40B, a valve 4002 is coupled to the flow path; however, valve 4002 does not have a vent 4006 which provide all the benefits noted above for a ventless valve.

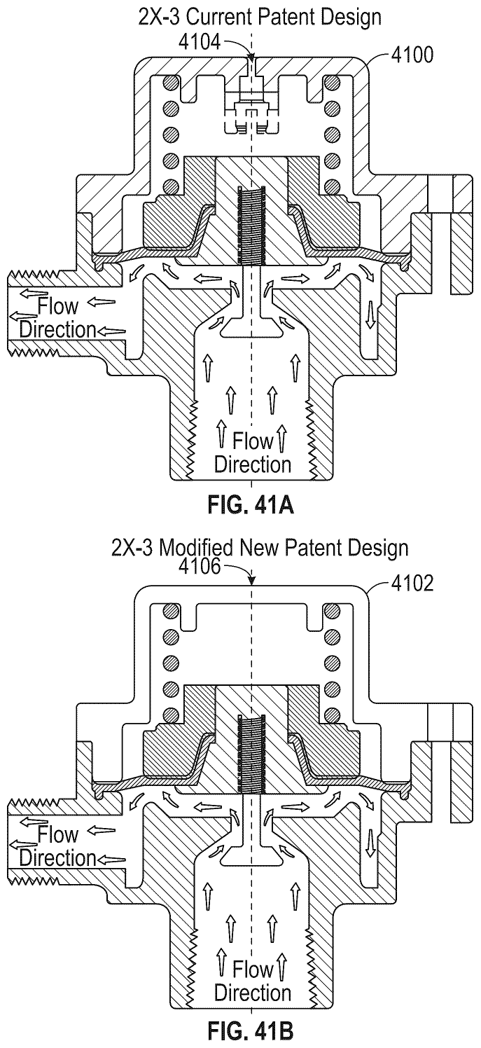

FIGS. 41A-41B show illustrations of a ventless CF Valve, according to various embodiments. In an example, a valve 4100 is coupled to a flow path. In this example, a vent 4104 is utilized in the valve 4100. In an embodiment shown in FIG. 41B, a valve 4102 is coupled to the flow path; however, valve 4102 does not have a vent 4106 which provide all the benefits noted above for a ventless valve.

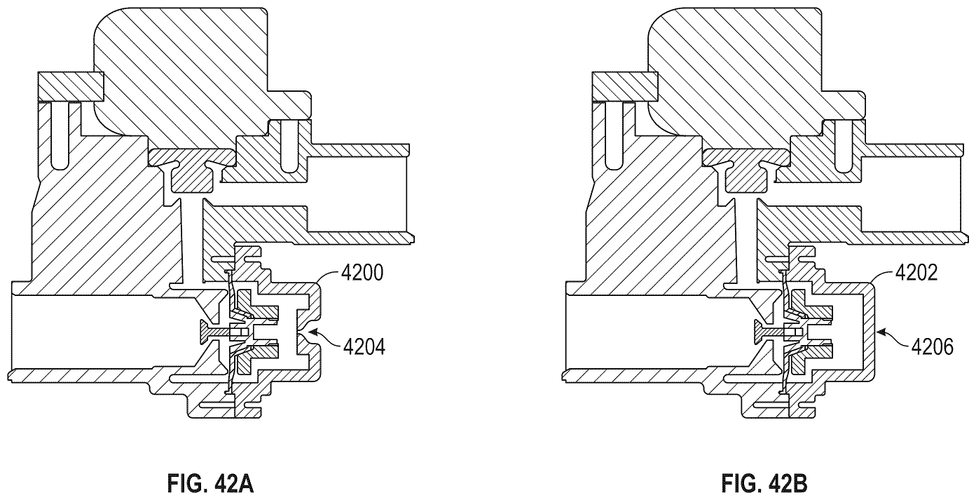

FIGS. 42A-42B show illustrations of a ventless CF Valve, according to various embodiments. In an example, a valve 4200 is coupled to a flow path. In this example, a vent 4204 is utilized in the valve 4200. In an embodiment shown in FIG. 42B, a valve 4202 is coupled to the flow path; however, valve 4202 does not have a vent 4206 which provide all the benefits noted above for a ventless valve.

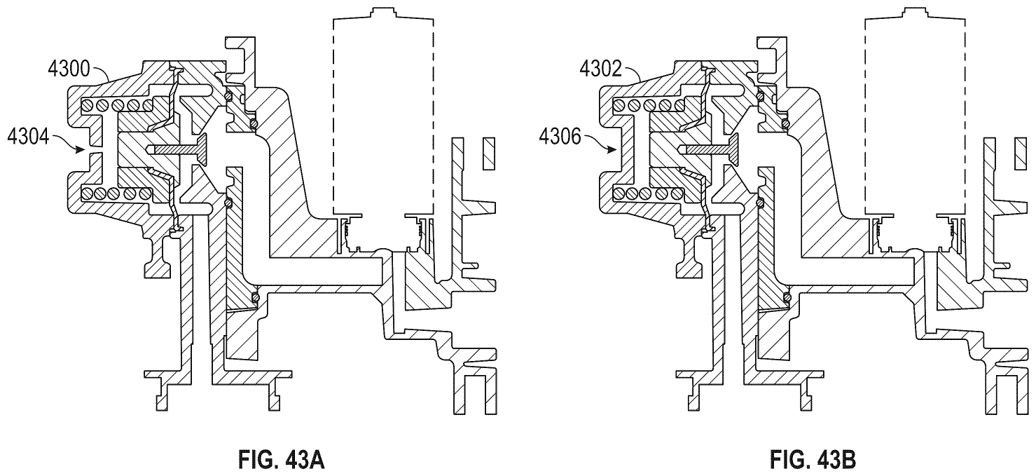

FIGS. 43A-43B show illustrations of a ventless CF Valve, according to various embodiments. In an example, a valve 4300 is coupled to a flow path. In this example, a vent 4304 is utilized in the valve 4300. In an embodiment shown in FIG. 43B, a valve 4302 is coupled to the flow path; however, valve 4302 does not have a vent 4306 which provide all the benefits noted above for a ventless valve.

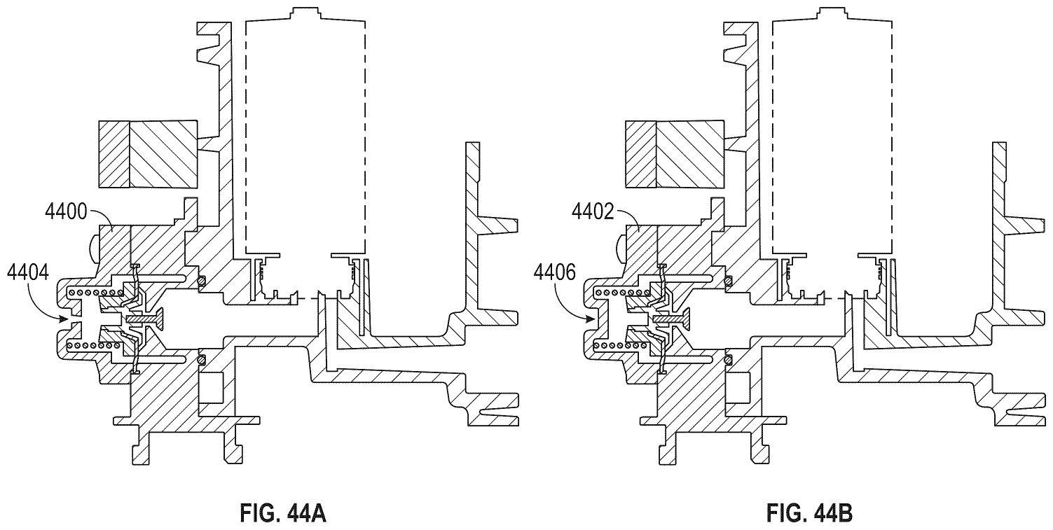

FIGS. 44A-44B show illustrations of a ventless CF Valve, according to various embodiments. In an example, a valve 4400 is coupled to a flow path. In this example, a vent 4404 is utilized in the valve 4400. In an embodiment shown in FIG. 44B, a valve 4402 is coupled to the flow path; however, valve 4402 does not have a vent 4406 which provide all the benefits noted above for a ventless valve.

The dispensing system and/or dispensing devices can be utilized with OJ, juices, dairy products, soft drinks, coffee, beer, wine, seltzer, and/or any components thereof (e.g., hops, alcohol, pulp, cream, flavors, syrups, etc.).

This disclosure relates generally to fluid valves, and is concerned in particular with a regulating valve that is normally closed, that is opened by a variable fluid pressure above a selected threshold level, and that when open, serves to deliver the fluid at a constant pressure and flow rate.

In one example, a regulating valve for receiving fluid at a variable pressure from a fluid source and for delivering the fluid at a substantially constant pressure and flow rate to a fluid applicator or the like, the valve including: a cup-shaped base having a cylindrical wall segment terminating in an upper rim, and an externally projecting first flange; a cap having an inwardly projecting ledge and an externally projecting second flange, the cup-shaped base and the cap being configured and dimensioned for assembly as a unitary housing, with the cylindrical wall segment of the cup-shaped base inserted into the cap, and with the extent of such insertion being limited by the abutment of the first flange with the second flange to thereby provide a space between the upper rim of the cup-shaped base and the inwardly projecting ledge of the cap; a barrier wall subdividing the interior of the housing into a head section and a base section; a modulating assembly subdividing the base section into a fluid chamber and a spring chamber; an inlet in the cap for connecting the head section to the fluid source; a port in the barrier wall connecting the head section to the fluid chamber, the port being aligned with a central first axis of the valve; an outlet in the cap communicating with the fluid chamber, the outlet being aligned on a second axis transverse to the first axis; a stem projecting from the modulating assembly along the first axis through the port into the head section; a flexible diaphragm supporting the modulating assembly within the housing for movement in opposite directions along the first axis, the diaphragm having an outer periphery captured in the space between the inwardly projecting ledge of the cap and a rim of the cylindrical wall segment of the cup-shaped base; a spring in the spring chamber, the spring being arranged to resiliently urge the modulating assembly into a closed position at which the diaphragm is in sealing contact with the barrier wall to thereby prevent fluid flow from the head section via the port and fluid chamber to the outlet, the spring acting in concert with the modulating assembly and the stem projecting therefrom to modulate the size of the port as an inverse function of the variable fluid pressure in the input sections whereby the pressure and flow rate of the fluid delivered to the outlet is maintained substantially constant, the valve being automatically actuated when the pressure of the fluid acting on the modulating assembly exceeds a threshold level, and being automatically closed when the pressure drops below the threshold level.

In one embodiment, a cleaning system may include: a CF Valve, the CF Valve coupled to a pressure source and a cleaning unit; the cleaning unit including a cleaning material bag and an outlet area, a cleaning solution recipe generated via the pressure source, the CF Valve, and the cleaning material bag; and a dispensing device coupled to the outlet area which receives a cleaning solution generated by the cleaning solution recipe.

In addition, the cleaning system may include: a dispensing device outlet area; a solenoid coupled to the CF Valve and the cleaning unit; a solenoid coupled to the CF Valve and the cleaning unit and one or more sensors; and/or one or more sensors. Further, a first sensor is configured to measure temperature data. In addition, the cleaning solution recipe is modified based on the measured temperature data. In addition, the CF Valve may include a housing having axially aligned inlet and outlet ports adapted to be connected respectively to the variable fluid supply and the fluid outlet; a diaphragm chamber interposed between the inlet and the outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet.

Further, the CF Valve may maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice.

In another example, the CF Valve may maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

In another embodiment, a cleaning system may include: a first CF Valve configured to be utilized with a flush function; a second CF Valve configured to be utilized with a clean function; a third CF Valve configured to be utilized with a dwell function; a fourth CF Valve configured to be utilized with a sanitize function; and a controller configured to initiate one or more cleaning recipes.

In various examples, the controller may initiate a first cleaning recipe including a first flush function, a clean function, a first dwell function, a sanitize function, a second dwell function, and a second flush function. In addition, the controller may initiate a second cleaning recipe including a first flush function, a clean function, a dwell function, a sanitize function, and a second flush function. Further, the controller may initiate a third cleaning recipe including a first flush function, a clean function, a second flush function, a sanitize function, a third flush function, a hold function, and a fourth flush function. In another example, the controller may initiate a fourth cleaning recipe including a first flush function, a clean function, a dwell function, and a second flush function. In addition, the controller may initiate a fifth cleaning recipe including a first flush function, a sanitize function, a dwell function, and a second flush function. Further, the controller may initiate a sixth cleaning recipe including a clean function, a dwell function, and a flush function. In another example, the controller may initiate a seventh cleaning recipe including a flush function, a clean function, and a dwell function.

A constant flow regulating valve includes a closure mechanism configured and arranged to override the modulating mode of the valve and to close the valve at fluid inlet pressures both below and above the valve's threshold level. The closure mechanism may be selectively deactivated to thereby allow the valve to assume its normal pressure responsive regulating functions. Embodiments of the regulating valve incorporate pressure relief devices and vent seals, with configurations suitable for incorporation into the trigger assemblies of portable sprayers.

This disclosure relates generally to fluid valves, and is concerned in particular with a regulating valve that operates in response to a variable fluid inlet pressure above a selected threshold level to deliver the fluid at a constant outlet pressure and flow rate. A closure mechanism is selectively operable either to accommodate the valve's normal pressure responsive regulating functions, or to override such functions by maintaining the valve in a closed state at inlet pressures both above and below the threshold level.

In one example, valves are normally closed in response to fluid inlet pressures below a threshold level, and operate in a modulating mode in response to variable fluid inlet pressures above the threshold level to deliver fluids at constant outlet pressures and flow rates. However, at fluid inlet pressures above the threshold level, such valves remain open and cannot serve as shut off valves, thus making it necessary to employ additional and separately operable valves to achieve this added function.

In accordance with one aspect of the present disclosure, the known regulating valves are modified to include closure mechanisms configured and arranged to override the modulating mode of the valves and to maintain closure of the valves at fluid inlet pressures both below and above the threshold level. The closure mechanisms may be selectively deactivated to thereby allow the valves to assume their normal pressure responsive regulating functions.

In accordance with still another aspect of the present disclosure, the vent opening communicating with the valve's spring chamber is provided with a seal which allows air to escape and enter the spring chamber, but which prevents the escape of liquid from the spring chamber in the event that the valve diaphragm is breached.

In accordance with another aspect of the present disclosure, a pressure relief mechanism is provided for relieving residual fluid inlet pressure below the threshold level when the valve is closed.

In one embodiment, a dispensing system may include: a display screen may display one or more icons, the one or more icons including at least a first icon, a second icon, and a third icon, the display screen may transmit one or more signals to one or more processors based on one or more user contacts with the display screen; the one or more processors may receive at least a first sales data, a second sales data, and a third sales data, where the one or more processors may: modify a first size of the first icon based on a first sales data for a first element relating to the first icon; modify a second size of the second icon based on a second sales data for a second element relating to the second icon; and modify a third size of the third icon based on a third sales data for a third element relating to the third icon; and a first dispensing unit which may dispense one or more elements based on the one or more signals.

In another embodiment, the first size of the first icon is larger than the second size of the second icon based on the first sales data being larger than the second sales data. In another example, the one or more processors may change the first element relating to the first icon to a fourth element and utilize a fourth sales data to determine a fourth size of the first icon. In another example, the one or more processors may modify at least one of first icon, the second icon, and the third icon based on receiving a time-of-day signal. In another example, the one or more processors may modify at least one of first icon, the second icon, and the third icon based on receiving an event signal. In another example, the one or more processors may modify at least one of first icon, the second icon, and the third icon based on receiving a promotional signal. In another example, the dispensing system may include a CF Valve in the first dispensing unit. In another example, the CF Valve includes a housing having axially aligned inlet and outlet ports adapted to be connected respectively to the variable fluid supply and the fluid outlet; a diaphragm chamber interposed between the inlet and the outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet. In another example, the CF Valve is configured to maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice. In another example, the CF Valve is configured to maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice. In another example, the first icon and the second icon are on a first side of the display screen and the third icon is on a second side of the display screen. In another example, the dispensing system may include a second dispensing unit, where the one or more processors may transmit a second display signal to the second dispensing unit based on one or more signals from the third icon and to transmit a third display signal to the first dispensing unit based one or more signals from at least one of the first icon and the second icon. In another example, the one or more processors may receive an external signal (via landline, wired, wireless, internet, etc.) to modify at least one of: the first icon, the second icon, the third icon; the first size, the second size, the third size, the first element, the second element, and the third element.

In one embodiment, a dispensing system may include: a display screen which may display one or more icons, the one or more icons including at least a first icon, a second icon, and a third icon, the display screen may transmit one or more signals to one or more processors based on one or more user contacts with the display screen; the one or more processors may receive at least a first data, a second, and a third data, where the one or more processors may modify: a first position of the first icon based on the first data for a first element relating to the first icon; modify a second position of the second icon based on the second data for a second element relating to the second icon; and modify a third position of the third icon based on the third data for a third element relating to the third icon; and a first dispensing unit may dispense one or more elements based on the one or more signals.

In another example, the one or more processors may receive an external signal to modify at least one of: the first icon, the second icon, the third icon; the first position, the second position, the third position, the first element, the second element, and the third element. In another example, the first position of the first icon is more prominent than the second position of the second icon based on a comparison of the first data to the second data.

In another embodiment, a dispensing system may include: a display screen which may display one or more icons, the one or more icons including at least a first icon, a second icon, a third icon, and a fourth icon, the display screen may transmit one or more signals to one or more processors based on one or more user contacts with the display screen; where the first icon has a first size, the second icon has a second size, the third icon has a third size, and the fourth icon has a fourth size; the one or more processors may receive at least a first sales data, a second sales data, a third sales data, and a fourth sales data, where the one or more processors may modify: the first size of the first icon based on the first sales data for a first element relating to the first icon; modify the second size of the second icon based on the second sales data for a second element relating to the second icon; modify the third size of the third icon based on the third sales data for a third element relating to the third icon; and modify the fourth size of the fourth icon based on the fourth sales data for a fourth element relating to the fourth icon; and a first dispensing unit may dispense one or more elements based on the one or more signals; where the modified first size of the first icon is larger than the first size based on the first sales data for the first element increasing versus a first previous sales data.

In another example, the modified second size of the second icon is smaller than the second size based on the second sales data for the second element decreasing versus a second previous sales data. In another example, the first icon and the second icon are on a first side of the display screen and the third icon and the fourth icon are on a second side of the display screen. In another example, the dispensing system may include a video advertisement and/or a still shot advertisement.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples. Any combination of any element in this disclosure with any other element in this disclosure is hereby disclosed. For example, an element on pages 2-3 can be combined with any element in this document (e.g., an element from pages 8-9).

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. A dispensing system comprising:
a display screen configured to display one or more icons, the one or more icons including at least a first icon, a second icon, and a third icon, the display screen configured to transmit one or more signals to one or more processors based on one or more user contacts with the display screen;
the one or more processors configured to receive at least a first sales data, a second sales data, and a third sales data, where the one or more processors are configured to: modify a first size of the first icon based on the first sales data for a first element relating to the first icon; modify a second size of the second icon based on the second sales data for a second element relating to the second icon; and modify a third size of the third icon based on the third sales data for a third element relating to the third icon; and
a first dispensing unit configured to dispense one or more elements based on the one or more signals.

2. The dispensing system of claim 1, wherein the one or more processors are configured to receive an external signal to modify at least one of: the first icon, the second icon, the third icon; the first size, the second size, the third size, the first element, the second element, and the third element.

3. The dispensing system of claim 1, wherein the first size of the first icon is larger than the second size of the second icon based on the first sales data being larger than the second sales data.

4. The dispensing system of claim 1, wherein the one or more processors are configured to change the first element relating to the first icon to a fourth element and utilize a fourth sales data to determine a fourth size of the first icon.

5. The dispensing system of claim 1, wherein the one or more processors are configured to modify at least one of first icon, the second icon, and the third icon based on receiving a time-of-day signal.

6. The dispensing system of claim 1, wherein the one or more processors are configured to modify at least one of first icon, the second icon, and the third icon based on receiving an event signal.

7. The dispensing system of claim 1, wherein the one or more processors are configured to modify at least one of first icon, the second icon, and the third icon based on receiving a promotional signal.

8. The dispensing system of claim 1, further comprising a CF Valve in the first dispensing unit.

9. The dispensing system of claim 7, wherein the CF Valve includes a housing having axially aligned inlet and outlet ports adapted to be connected respectively to the variable fluid supply and the fluid outlet; a diaphragm chamber interposed between the inlet and the outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet.

10. The dispensing system of claim 7, wherein the CF Valve is configured to maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice.

11. The dispensing system of claim 7, wherein the CF Valve is configured to maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

12. The dispensing system of claim 1, wherein the first icon and the second icon are on a first side of the display screen and the third icon is on a second side of the display screen.

13. The dispensing system of claim 11, further comprising a second dispensing unit, where the one or more processors are configured to transmit a second display signal to the second dispensing unit based on one or more signals from the third icon and to transmit a third display signal to the first dispensing unit based one or more signals from at least one of the first icon and the second icon.

14. A dispensing system comprising:
a display screen configured to display one or more icons, the one or more icons including at least a first icon, a second icon, and a third icon, the display screen configured to transmit one or more signals to one or more processors based on one or more user contacts with the display screen;
the one or more processors configured to receive at least a first data, a second data, and a third data, where the one or more processors are configured to: modify a first position of the first icon based on the first data for a first element relating to the first icon; modify a second position of the second icon based on the second data for a second element relating to the second icon; and modify a third position of the third icon based on the third data for a third element relating to the third icon; and
a first dispensing unit configured to dispense one or more elements based on the one or more signals.

15. The dispensing system of claim 1, wherein the one or more processors are configured to receive an external signal to modify at least one of: the first icon, the second icon, the third icon; the first position, the second position, the third position, the first element, the second element, and the third element.

16. The dispensing system of claim 1, wherein the first position of the first icon is more prominent than the second position of the second icon based on a comparison of the first data to the second data.

17. A dispensing system comprising:
a display screen configured to display one or more icons, the one or more icons including at least a first icon, a second icon, a third icon, and a fourth icon, the display screen configured to transmit one or more signals to one or more processors based on one or more user contacts with the display screen;
where the first icon has a first size, the second icon has a second size, the third icon has a third size, and the fourth icon has a fourth size;
the one or more processors configured to receive at least a first sales data, a second sales data, a third sales data, and a fourth sales data, where the one or more processors are configured to: modify the first size of the first icon based on the first sales data for a first element relating to the first icon; modify the second size of the second icon based on the second sales data for a second element relating to the second icon; modify the third size of the third icon based on the third sales data for a third element relating to the third icon; and modify the fourth size of the fourth icon based on the fourth sales data for a fourth element relating to the fourth icon; and
a first dispensing unit configured to dispense one or more elements based on the one or more signals;
wherein the modified first size of the first icon is larger than the first size based on the first sales data for the first element increasing versus a first previous sales data.

18. The dispensing system of claim 17, wherein the modified second size of the second icon is smaller than the second size based on the second sales data for the second element decreasing versus a second previous sales data.

19. The dispensing system of claim 17, wherein the first icon and the second icon are on a first side of the display screen and the third icon and the fourth icon are on a second side of the display screen.

20. The dispensing system of claim 17, further comprising at least one of a video advertisement and a still shot advertisement.
